(19) United States
(12) Patent Application Publication
(10) Pub. No.: US 2006/0266473 A1
(43) Pub. Date: Nov. 30, 2006

(54) Bonding by induced high-rate of shear deformation

(75) Inventors: Nagabhusan Senapati, Appleton, WI (US); Shiming Zhuang, Menasha, WI (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 11/138,099

(22) Filed: May 26, 2005

(51) Int. Cl. B32B 37/00

(52) U.S. Cl. 156/290; 156/308.4

(57) ABSTRACT

The bonding method and apparatus (20) includes a delivering of a target web (26) having one or more selected bonding materials through a nip region (30) between at least one cooperating pair of rotatable bonding rollers (32, 34), thereby forming and producing a bonded web (28). In a particular aspect, a pattern roller (32) can be configured to provide a distinctively high, pattern surface speed. In another aspect, the pair of bonding rollers can be configured to provide a distinctively low, bonding pressure value. In further aspects, an anvil roller (34) can be provided with an anvil surface speed, and the anvil surface speed can be configured to be substantially equal to the pattern surface speed.

### FIELD OF THE INVENTION

The present invention relates to a technique for forming a bonded web. More particularly, the present invention pertains to a technique for forming a bonded web by inducing a high-rate of shear deformation.

### BACKGROUND OF THE INVENTION

Polymeric films and fabrics have been bonded by employing conventional techniques such as adhesive bonding, thermal bonding, and ultrasonic bonding. The bonding techniques have delivered the target webs of materials through the nip formed between a pair of counter-rotating bonding rollers, and have included bonding rollers with smooth surfaces, bonding rollers with surfaces that include distributed patterns of bonding elements, and combinations of rollers with smooth and patterned surfaces. The bonding techniques have employed combinations of heat and pressure to effect the desired bonding. In particular arrangements, the bonding rollers have been differently constructed or differently rotated to produce a surface speed differential between the bonding rollers. Typically, it has been recognized that the bonding techniques produce better bonding when conducted at lower bonding speeds.

Conventional bonding techniques, such as those described above, have not provided a desired combination of bonding speed and bond strength between the target materials. Additionally, the non-adhesive bonding techniques have had difficulty forming adequate bonds between materials that have a large difference in their melting-point temperatures. As a result, there has been a continued need for improved bonding techniques that can provide desired bond strengths while operating at high bonding speeds.

### BRIEF DESCRIPTION OF THE INVENTION

The present invention provides a distinctive bonding method and apparatus. Generally stated, the bonding method includes a delivering of a target web having one or more selected bonding materials through a nip region between at least one cooperating pair of bonding rollers to form a bonded web. In a particular aspect, a pattern roller can be configured with a distinctively high, pattern surface speed. In another aspect, the pair of bonding rollers can be configured to provide a distinctively low, bonding pressure value. In further aspects, an anvil roller can be provided with an anvil surface speed, and the anvil surface speed can be configured to be substantially equal to the pattern surface speed.

The method and apparatus of the invention can more efficiently produce bonds having a desired, sufficiently high strength value. The desired bonding can be produced while operating at relatively low pressure values and at very high speeds. The desired bonding can also be produced while operating at ordinary room temperatures. Additionally, the method and apparatus of the invention can produce the desired bonding between work materials that are ordinarily deemed to be incompatible when employing conventional thermal or ultrasonic bonding techniques.

### BRIEF DESCRIPTION OF THE DRAWINGS

The invention will be better understood by reference to the following description of the invention taken in conjunction with the accompanying drawings, wherein:

FIG. 1 shows a schematic, side elevational view of a representative method and apparatus having a rotatable pattern roller and a counter-rotatable anvil roller.

FIG. 1A shows a schematic, perspective view of a representative method and apparatus having a rotatable pattern roller and a counter-rotatable anvil roller.

FIG. 2 shows a representative pattern of bonding pins on a pattern roller.

FIG. 2A shows individual bonding pins that extend a selected height from an outer surface of a pattern roller.

FIG. 2B shows a representative pattern of non-circular bonding pins on a pattern roller

FIG. 3 is a representative graph that shows how the bond strength of a first combination of bonded web materials can vary with bonding speed and nip force value.

FIG. 4 is a representative graph that shows how the bond strength of a second combination of bonded web materials can vary with bonding speed and nip force value.

FIG. 5 is a representative graph that shows how the bond strength of a third combination of bonded web materials can vary with bonding speed and nip force.

FIG. 6 is a representative graph that shows how the bond strength of a fourth combination of bonded web materials can vary with bonding speed and nip force value.

FIG. 7 is a representative graph that shows how the bond strength of a fifth combination of bonded web materials can vary with bonding speed and nip force value.

FIG. 8 is a representative graph that shows how the bond strength of a sixth combination of bonded web materials can vary with bonding speed and nip force value at a first bonder temperature.

FIG. 9 is a representative graph that shows how the bond strength of the sixth combination of bonded web materials can vary with bonding speed and nip force value at a second bonder temperature.

FIG. 10 is a representative graph that shows how the bond strength of the sixth combination of bonded web materials can vary with bonding speed and nip force value at a third bonder temperature.

FIG. 11 is a representative graph that shows how the bond strength of the sixth combination of bonded web materials can vary with bonding speed and bonder temperature for a first bonding nip force value.

FIG. 12 is a representative graph that shows how the bond strength of the sixth combination of bonded web materials can vary with bonding speed and bonder temperature for a second bonding nip force value.

FIG. 13 is a representative graph that shows how the bond strength of the sixth combination of bonded web materials can vary with bonding speed and bonder temperature for a third bonding nip force value.

FIG. 14 is a representative graph that shows how the bond strength of the sixth combination of bonded web materials can vary with bonding speed and bonder temperature for a fourth bonding nip force value.

FIG. 15 is a representative graph that shows how the bond strength of the fourth combination of bonded web materials can vary with bonding speed and bonder nip force value at a first bonding temperature.

FIG. 16 is a representative graph that shows how the bond strength of the fourth combination of bonded web materials can vary with bonding speed and bonder nip force value at a second bonding temperature.

FIG. 17 is a representative graph that shows how the bond strength of the fourth combination of bonded web materials can vary with bonding speed and bonder nip force value at a third bonding temperature.

FIG. 18 is a representative graph that shows how the bond strength of the fourth combination of bonded web materials can vary with bonding speed and bonder temperature at a first bonding nip force value.

FIG. 19 is a representative graph that shows how the bond strength of the fourth combination of bonded web materials can vary with bonding speed and bonder temperature at a second bonding nip force value.

FIG. 20 is a representative graph that shows how the bond strength of the fourth combination of bonded web materials can vary with bonding speed and bonder temperature at a third bonding nip force value.

FIG. 21 is a representative graph that shows how the bond strength of the fourth combination of bonded web materials can vary with bonding speed and bonder temperature at a fourth bonding nip force value.

FIG. 22 is a representative graph that shows how the bond strength of a third combination of bonded web materials can vary with bonding speed and nip force value at a first bonding temperature.

FIG. 23 is a representative graph that shows how the bond strength of the third combination of bonded web materials can vary with bonding speed and nip force value at a second bonding temperature.

FIG. 24 is a representative graph that shows how the bond strength of the third combination of bonded web materials can vary with bonding speed at different temperatures and at the first and second nip force values.

FIG. 25 is a representative graph that shows how the bond strength of the third combination of bonded web materials can vary with bonding speed at different temperatures and at the third and fourth nip force values.

### DETAILED DESCRIPTION OF THE INVENTION

It should be noted that, when employed in the present disclosure, the terms “comprises”, “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As used herein, the term “nonwoven” refers to a fabric web that has a structure of individual fibers or filaments which are interlaid, but not in an identifiable repeating manner.

As used herein, the terms “spunbond” or “spunbonded fiber” refer to fibers which are formed by extruding filaments of molten thermoplastic material from a plurality of fine, usually circular, capillaries of a spinneret, and then rapidly reducing the diameter of the extruded filaments.

As used herein, the phrase “meltblown” fibers refers to fibers formed by extruding a molten thermoplastic material through a plurality of fine, usually circular, die capillaries as molten threads or filaments into a high velocity, usually heated, gas (e.g., air) stream which attenuates the filaments of molten thermoplastic material to reduce their diameter. Thereafter, the meltblown fibers are carried by the high velocity gas stream and are deposited on a collecting surface to form a web of randomly disbursed meltblown fibers.

“Coform” as used herein is intended to describe a blend of meltblown fibers and cellulose fibers that is formed by air forming a meltblown polymer material while simultaneously blowing air-suspended cellulose fibers into the stream of meltblown fibers. The meltblown fibers containing wood fibers are collected on a forming surface, such as provided by a foraminous belt. The forming surface may include a gas-pervious material, such as spunbonded fabric material, that has been placed onto the forming surface.

As used herein, the phrase “absorbent article” refers to devices which absorb and contain body liquids, and more specifically, refers to devices which are placed against or near the skin to absorb and contain the various liquids discharged from the body. The term “disposable” is used herein to describe articles that are not intended to be laundered or otherwise restored or reused as an absorbent article after a single use. Disposable articles are typically intended for limited use, and are ordinarily discarded after the article has been soiled. Examples of such disposable absorbent articles include, but are not limited to: health care related products including surgical drapes, gowns, covers and sterile wraps; personal care absorbent products such as feminine hygiene products (e.g., sanitary napkins, pantiliners, tampons, interlabial devices and the like), infant diapers, children's training pants, adult incontinence products and the like; as well as absorbent wipes and covering mats.

Disposable absorbent articles may, for example, include a liquid pervious topsheet, a substantially liquid impervious backsheet joined to the topsheet, and an absorbent core positioned and held between the topsheet and the backsheet. The topsheet is operatively permeable to the liquids that are intended to be held or stored by the absorbent article, and the backsheet may be substantially impermeable or otherwise operatively impermeable to the intended liquids. The absorbent article may also include other components, such as liquid wicking layers, liquid distribution layers, barrier layers, and the like, as well as combinations thereof.

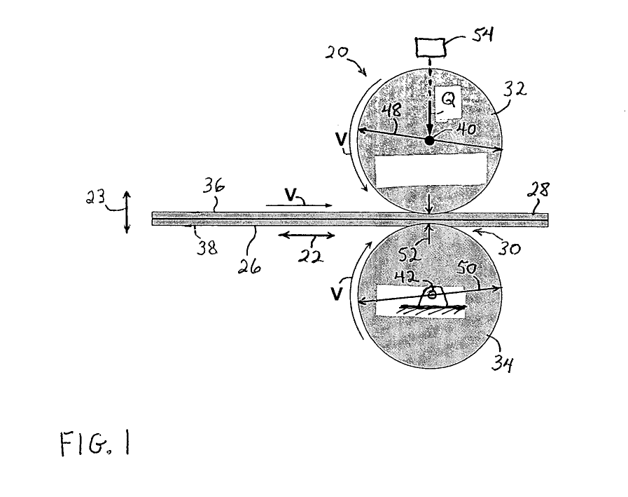

With reference to FIGS. 1 and 1A, the process and apparatus 20 of the invention can have a lengthwise, machine-direction 22 which extends longitudinally, a lateral cross-direction 24 which extends transversely, and an appointed z-direction 23. For the purposes of the present disclosure, the machine-direction 22 is the direction along which a particular component or material is transported length-wise along and through a particular, local position of the apparatus and method. The cross-direction 24 lies generally parallel to the local horizontal, and is aligned perpendicular to the local machine-direction 22. The z-direction is aligned substantially perpendicular to both the machine-direction 22 and the cross-direction 24, and extends generally along a depth-wise, thickness dimension of the appointed material targeted for work.

The bonding method and apparatus 20 includes a delivering of a target web 26 having one or more selected bonding materials through a nip region 30 between at least one cooperating pair of rotatable bonding rollers, thereby forming and producing a bonded web 28. In a particular aspect, a pattern roller 32 can be configured to provide a distinctively high, pattern surface speed. In another aspect, the pair of bonding rollers can be configured to provide a distinctively low, bonding pressure value. In further aspects, an anvil roller 34 can be provided with an anvil surface speed, and the anvil surface speed can be configured to be substantially equal to the pattern surface speed.

The method and apparatus of the invention can provide a low cost and low maintenance, rotary pressure bonding (RPB) technology. The method and apparatus can more efficiently produce bonds having a desired, sufficiently high strength value. In particular features, the sufficient level of bonding can be produced while operating at relatively low pressure values and at very high speeds. In other aspects, the method and apparatus can produce distinctively interconnected bonds having high, attachment strength values. The desired bonding can also be accomplished while operating at ordinary room temperatures. Additionally, the method and apparatus of the invention can produce adequate bonding between work materials that are ordinarily considered to be incompatible, particularly when employing conventional thermal or ultrasonic bonding techniques. It should be readily appreciated that the method and apparatus of the invention can be employed in any suitable manufacturing system that includes a high-speed bonding of selected web materials. For example, the method and apparatus can be employed in the construction of reusable articles, disposable articles or disposable absorbent articles or the like, as desired.

The target web 26 can include one or more selected materials. As representatively shown, for example, the target web can include a first web of a selected, first material 36 and at least a second web of a selected, second material 38. The first and second materials can be different or substantially the same. Optionally, the target web may include one or more additional webs of material. Any suitable web of material may be employed. Such webs can, for example, include woven fabrics, nonwoven fabrics, spunbond fabrics, meltblown fabrics, carded-web fabrics, bonded-carded web fabrics, composite fabrics, polymer films, perforated polymer film webs, net materials, or the like, as well as combinations thereof. Examples of suitable nonwoven webs can include spunbond (SB) fabrics, spunbond-meltblown-spunbond (SMS) laminates, neck-bonded-laminates (NBL), Point UnBonded (PUB) fabrics, Vertical Filament Laminates (VFL), Stretch Bonded Laminates (SBL), or the like. The target web 26 may also include other desired materials. For example, the desired materials may include superabsorbent polymer materials, absorbent natural fibers, such as woodpulp fibers, absorbent synthetic fibers, or the like, as well as combinations thereof.

In desired arrangements, at least one of the first and second webs can be a fabric web. Accordingly, the invention can be configured to bond a nonwoven fabric to a similar or substantially identical nonwoven fabric; bond a nonwoven fabric to a different nonwoven fabric; or bond a nonwoven fabric to a film material.

In another feature, at least one and desirably both of the employed webs can include polymeric materials. Desirably, the employed polymeric materials can operatively be heat processible and thermally bondable. For example, the selected polymeric web material can include polyester, polypropylene, polyethylene, nylon, or other heat-bondable materials, polyolefins, such as copolymers of polypropylene and polyethylene, linear low-density polyethylene, aliphatic esters such as polylactic acid, and the like, as well as combinations thereof.

The method and apparatus of the invention can include at least one cooperating pair of counter-rotatable or counter-rotating bonding rollers, and the bonding rollers can include at least one rotatable pattern roller 32 and at least one rotatable anvil roller 34. The pattern roller 32 has an operative axis of rotation 40, and can be provided with selected plurality of pattern bonding elements 44, which may be arrayed or otherwise arranged in any operative distribution. Such distributions of bonding elements are conventional and well known. The individual pattern bonding elements can, for example, be pin elements, and the pin elements can have any operative, size, shape and/or cross-section.

The method and apparatus of the invention can provide a distinctively high deformation rate or strain rate (length per length, per unit time) during the high-speed compression of the target web. The compressive mechanical deformation can induce an internal heating of the target web 26, and cause a temperature increase within the deformed materials of the target web. At the same time, thermal conduction can transfer heat away from the deformed target web materials. As a result, the net temperature rise within the deformed target web will be determined by the difference between the internal heating due to the web deformation, and the heat loss due to thermal conduction. At conventional previously employed, low bonding speeds, a large amount of heat can transfer away from the deformed material into the cooler parts of the target web and into the bonder rollers during the deformation period of the bonding process. As a result, the strain-induced heating can be excessively limited, and the conventional bonding systems have required auxiliary heating to develop a sufficient bond strength.

The method and apparatus of the invention can provide a distinctively high rate of mechanical deformation or mechanical strain, which produces an increased rate of internal heating that is significantly higher than the rate of heat loss due to thermal conduction. At high bonding speeds, mechanical deformation induced internal heating is so rapid that only a small amount of heat is lost due to thermal conduction. In a particular feature, the internal heating process can be nearly adiabatic. When the nip force is sufficiently high and sufficiently large local deformations are generated within the areas to be bonded, an auxiliary, pre-heating of the target web or bonding rollers is not needed during the bonding operation to obtain an adequate bond strength. It has been found that for a given nip force value and set of bonder equipment, the deformation strain rate can increase approximately linearly with respect to the bonding speed. Additionally, the deformation rate can increase approximately linearly with respect to a decrease of the diameter the pattern roller 32 or anvil roller 34. In a particular feature of the invention, the deformation strain rate (length per length, per unit time) during the bonding compression of the target web materials can, for example, be within the range of about 1*10³-1*10⁴ sec⁻¹.

The thermal properties of the materials employed to construct the bonder rollers can also affect the amount of temperature increase produced within webs being deformed by the pressure bonding system. The larger the thermal conductivity of the bonder rollers, the smaller the temperature increase within the deformed materials of the target web for a given set of bonding conditions. Materials with a small thermal conductivity are desired, if the bonder is to be conducted without a significant amount of auxiliary heating. For example, the lower thermal conductivity of bonding rollers having peripheral bonding surfaces composed of steel can be lower than the thermal conductivity of bonding rollers having peripheral surfaces composed of copper. The bonding rollers with peripheral bonding surfaces composed of materials having the relatively smaller thermal conductivity coefficients can help improve the performance of the method and apparatus of the invention. The lower thermal conductivity can help reduce the need for auxiliary heating, and the bonding rollers can more efficiently raise the web materials towards their melting points to generate desired bonding strengths.

The pattern roller can also be provided with a selected pattern-roll diameter 48 and can be constructed from any operative material. In particular aspects, the pattern-roll diameter can be at least a minimum of about 3 inch (about 76 mm). The pattern-roll diameter can alternatively be at least about 4 inch (about 101 mm), and can optionally be at least about 6 inch (about 152 mm) to provide desired benefits. In other aspects, the pattern-roll diameter can be up to a maximum of about 24 inch (about 610 mm), or more. The pattern-roll diameter can alternatively be up to about 18 inch (about 457 mm), and can optionally be up to about 12 inch (about 305 mm) to provide desired effectiveness. In desired configurations, for example, the pattern-roll diameter can be about 6.1 inch, 6.5 inch, 6.9 inch, or 12 inch (about 156 mm, 166 mm, 176 mm, or 304 mm; respectively). Where the pattern-roll diameter is within the desired values, the method and apparatus of the invention can be more compact, and can reliably and efficiently provide desired bonding strengths.

With regard to the diameters of the employed pattern roller 32 and anvil roller 34, it can be observed that for a given effective (or equivalent) nip force value, the bond strength of webs bonded with larger diameter bonding rollers, e.g. with 12 inch (304 mm) pattern and anvil rollers, can be lower than the bond strength of webs bonded with a smaller diameter bonding rollers, e.g. with a 7 inch (176 mm) pattern roller and a 6.5 inch (165 mm) anvil roller. Without intending to be bound by any particular theory, it is believed that an important factor is the deformation (strain) rate of the webs passing through the nip region 30 between the rotating pattern and anvil rollers. At a given surface speed, the deformation rate increases when the diameters of the pattern and anvil rollers decrease. Therefore, for a given nip force value and bonding speed, the relatively smaller diameter rollers can provide a relatively larger deformation rate and a relatively larger deformation strain. The larger plastic deformation can lead to a larger amount of plastic flow, and the larger amount of plastic flow can provide a greater bond strength. Other factors may contribute to this result. For example, some web materials can be more rate-sensitive than other materials. Additionally, the plastic deformation of the web material can be non-linear and dependent on the deformation history of the material. Since a significant amount of heat is generated during the dynamic plastic deformation, the thermal properties of the web material may also have a significant role.

As representatively shown in FIG. 1A, the pattern roller 32 can be configured to include a shaft member 56 and plurality of two or more pattern sleeves 58. The illustrated example includes a pair of substantially identical pattern sleeves. The outer diameter of the pattern sleeves provides the diameter of the pattern roller, and the bonding elements 44 can be operatively distributed on the outer peripheral surface 60 of the pattern roller 32 (e.g. on the outer peripheral surface of the pattern sleeves 58). Alternatively, the pattern roller 32 can have the form of a generally unitary cylinder with the selected pattern of bonding elements distributed on and along the outer surface of the cylinder. For example, two substantially identical patterns of bonding elements can be fabricated on the outer surface of the cylinder and spaced apart by a desired distance along the axial direction of the cylinder.

The pattern roller can have an array of bonding elements distributed on an outer surface of the pattern roller. The individual bonding elements may have any operative configuration, and any operative array may be employed. The array of bonding elements may be distributed in a pattern that is regular, irregular, linear, curvilinear, nonlinear, or the like, as well as combinations thereof. Techniques for constructing the individual bonding elements and the distributed, pattern arrays are conventional and well known in the art.

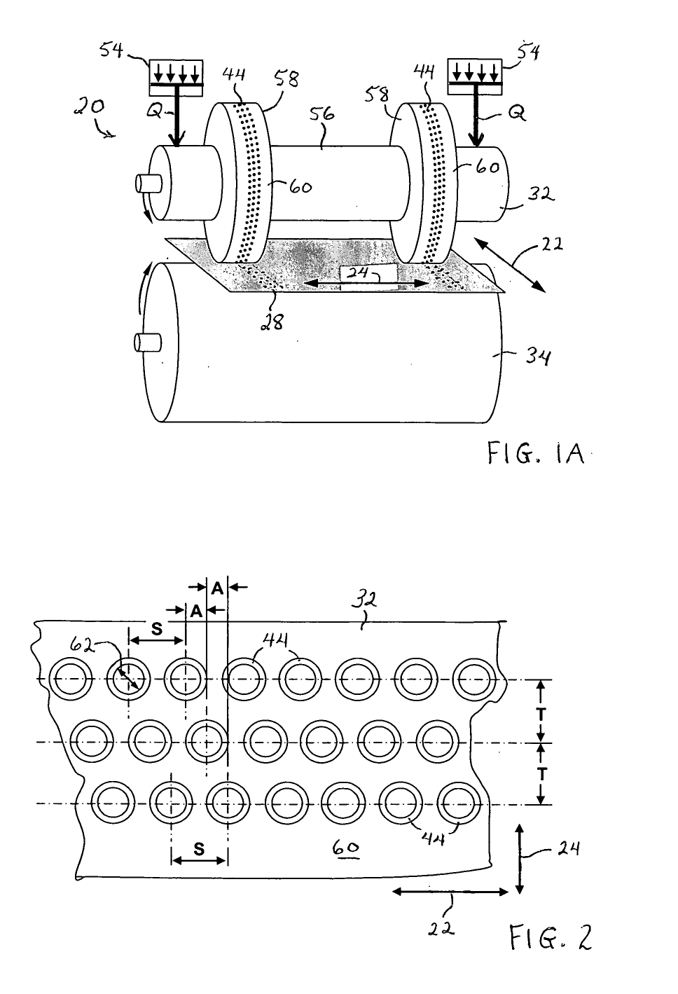

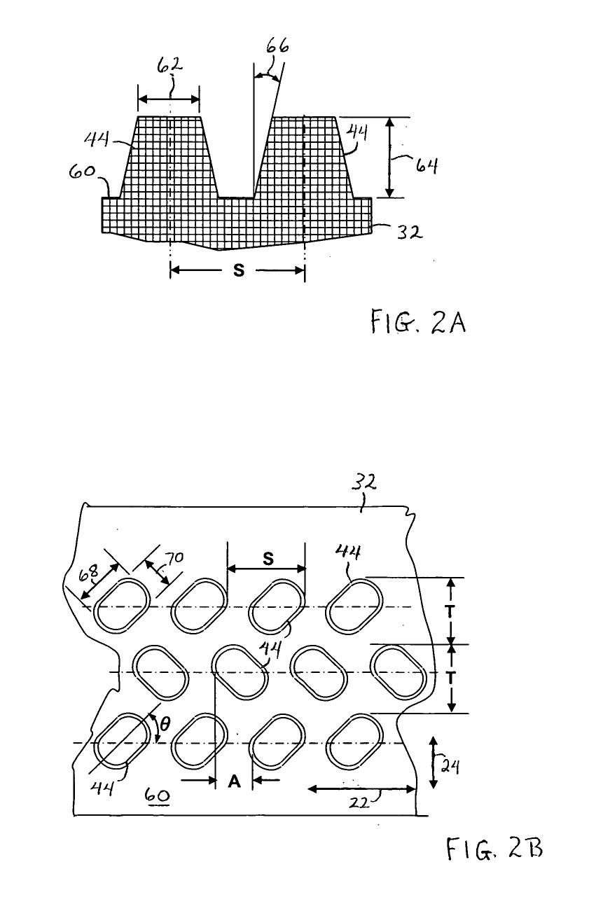

With reference to FIGS. 2 and 2A, the employed bonding pins or other bonding elements 44 can be configured with a generally tapered cylindrical shape having a pin diameter 62, a pin height 64 and a pin taper angle 66.

In particular aspects, the pin diameter 62 can be at least a minimum of about 0.015 inch (about 0.38 mm). The pin diameter can alternatively be at least about 0.025 inch (about 0.64 mm), and can optionally be at least about 0.03 inch (about 0.76 mm) to provide desired benefits. In other aspects, the pin diameter can be up to a maximum of about 0.25 inch (about 6.4 mm), or more. The pin diameter can alternatively be up to about 0.15 inch (about 3.8 mm), and can optionally be up to about 0.08 inch (about 2.03 mm) to provide desired effectiveness.

In further aspects, the pin height 64 can be at least a minimum of about 0.004 inch (about 0.1 mm). The pin height can alternatively be at least about 0.015 inch (about 0.38 mm), and can optionally be at least about 0.025 inch (about 0.64 mm) to provide desired benefits. In still other aspects, the pin height can be up to a maximum of about 0.25 inch (about 6.4 mm), or more. The pin height can alternatively be up to about 0.1 inch (about 2.54 mm), and can optionally be up to about 0.05 inch (about 1.27 mm) to provide desired effectiveness.

The pin taper angle 66 can be as low as 0°. The pin taper angle can alternatively be at least about 10°, and can optionally be at least about 15° to provide desired benefits. In other aspects, the pin taper angle 66 can be up to a maximum of about 60°, or more. The pin taper angle can alternatively be up to about 30°, and can optionally be up to about 22.5° to provide desired effectiveness.

The distribution pattern of the bonding elements 44 can have a machine-direction (MD) pin spacing distance S along the circumferential direction of the pattern roller, a cross-direction (CD) pin spacing distance T along the axial direction of the pattern roller, and a MD pin offset spacing distance A along the circumferential direction of the pattern roller. When the pins are substantially circular, for example, the MD pin spacing distance S can be as low as a minimum distance determined by the formula:
S=d+(2*H*tangent (α))
where: d=pin diameter (62);

H=pin height (64);

α=pin taper angle (66).

In other aspects, the MD pin spacing distance can be up to a maximum distance determined by the formula:
S=(5*d)+(10*H*tangent(α)).
Alternatively, the MD pin spacing distance can be up to a maximum distance determined by the formula:
S=(2*d)+(4*H*tangent(α)).
Optionally, the MD pin spacing distance can be up to a maximum distance determined by the formula:
S=(1.5*d)+(2*H*tangent(α)).

In further aspects, the CD pin spacing distance T can be as low as a minimum distance determined by the formula:
T=(0.5*d)+(2*H*tangent (α))
where:

H=pin height (64);

α=pin taper angle (66).

Alternatively, the CD pin spacing distance T can be as low as a minimum distance determined by the formula:
T=(0.75*d)+(2*H*tangent (α))

In still other aspects, the CD pin spacing distance can be up to a maximum distance determined by the formula:
T=(5*d)+(10*H*tangent(α)).
Alternatively, the CD pin spacing distance can be up to a maximum distance determined by the formula:
T=(2*d)+(4*H*tangent(α))
Optionally, the CD pin spacing distance can be up to a maximum distance determined by the formula:
T=(1.25*d)+(2*H*tangent(α))

The MD pin offset distance A can be as low as zero. The MD pin offset distance can alternatively be at least a minimum distance determined by the calculation:
A=0.5*d; where d=pin diameter (62); and
can optionally be at least the distance determined by the calculation:
A=0.7*d,
to provide desired benefits.

In other aspects, the MD pin offset distance A can be as large as the MD pin spacing distance S. The MD pin offset distance can alternatively be up to a maximum of about one pin diameter, d, and can optionally be up to about 0.8*d, to provide desired effectiveness.

The pattern of bonding elements can be configured to have any operative distribution. The pattern may be intermittent, arranged in two or more discrete segments, or substantially continuous along the circumferential machine-direction 22 of the pattern roller. Additionally, the pattern may be intermittent, arranged in two or more discrete segments, or substantially continuous along the axial cross-direction 24 of the pattern roller.

The pattern of bonding elements may also include any operative number of pin lines that extend circumferentially along the machine-direction 22. In particular aspects, the number of pin lines can be at least a minimum of about 1. The number of pin lines can alternatively be at least about 2, and can optionally be at least about 3 to provide desired bonding. In other aspects, the number of pin lines can be up to a maximum of about 15, or more. The number of pin lines can alternatively be up to about 6, and can optionally be up to about 4 to provide desired effectiveness. As representatively shown in FIGS. 2 and 2B, the pattern of bonding elements can be arranged to provide 3 circumferentially-extending lines of bonding elements 44 (e.g. lines of pins).

The peripheral bonding surface of an individual bonding element can have a selected bonding surface area. In particular aspects, the bonding surface area can be at least a minimum of about 0.14 mm². The bonding surface area can alternatively be at least about 0.4 mm², and can optionally be at least about 0.6 mm² to provide desired benefits. In other aspects, the bonding surface area can be up to a maximum of about 40 mm², or more. The bonding surface area can alternatively be up to about 15 mm², and can optionally be up to about 4 mm² to provide desired effectiveness.

Another aspect of the invention can include distinctive pin area fraction B which can be determined by the following formula:
B=G+(S*T)
where: G=bonding surface area of an individual bonding element (e.g. bonding surface area of an individual pin);

S=MD pin spacing distance along the circumferential direction of the pattern roller;

T=CD pin spacing distance along the axial direction of the pattern roller.

For circular pins; G=(π*d²)÷4. Accordingly, for circular pins:
B=(π*d²)÷(4*S*T)
where: π=3.14;

d=pin diameter (62).

In particular aspects, the pin area fraction can be at least a minimum of about 0.1. The pin area fraction can alternatively be at least about 0.2, and can optionally be at least about 0.25 to provide desired benefits. In other aspects, the pin area fraction can be up to a maximum of about 0.75, or more. The pin area fraction can alternatively be up to about 0.5, and can optionally be up to about 0.35 to provide improved effectiveness.

Alternative arrangements of the invention can include non-circular bonding elements, as representatively shown in FIG. 2B. For example, the bonding elements can be provided by pins having a generally oval-shape, with a relatively longer axis 68 and a relatively shorter axis 70. The longer axis 68 can be oriented at any operative slant angle θ relative to the machine-direction 22. The slant angle can be within the range of about ±80° relative to the machine-direction, and can desirably be within the range of about ±45° relative to the machine-direction to provide desired performance.

Where the pin sizes, pin shapes, pin spacings, pattern distributions and other parameters of the bonding elements are within the desired values, the method and apparatus of the invention can more reliably and more efficiently provide desired bonding strengths.

The anvil roller 34 has an operative axis of rotation 42, and can be constructed from any operative material. Additionally, the anvil roller can be provided with a selected anvil-roll diameter 50. In particular aspects, the anvil-roll diameter can be at least a minimum of about 3 inch (about 76 mm), and can alternatively be at least about 5 inch (about 127 mm) to provide desired benefits. In other aspects, the anvil-roll diameter 50 can be up to a maximum of about 24 inch (about 610 mm), or more, and can alternatively be up to about 12 inch (about 305 mm) to provide desired effectiveness. For example, desired arrangements can include an anvil-roll diameter 50 of about 6.06 inch, 6.14 inch, 6.5 inch or 12 inch (about 154 mm, 156 mm, 165 mm or 304 mm, respectively).

Where the anvil-roll diameter is within the desired values, the method and apparatus of the invention can be more compact, and can reliably and efficiently provide desired bonding strengths.

The anvil roller can have an outer peripheral anvil surface which is substantially smooth, and substantially free of discrete bonding elements. Optionally, the anvil roller surface may include an operative array of anvil bonding elements. The anvil bonding elements can be configured to cooperate with the array of pattern elements 44. For example, the anvil bonding elements may have exactly the same or similar pattern of pin elements with less pin height. Alternatively, the anvil bonding elements may have exactly the same or similar pattern of pin elements, with less pin height and larger pin diameter. Optionally, the anvil bonding elements may have a pattern of aperturing elements to aperture holes on the appointed target webs.

An operative drive technique or system may be employed to counter-rotate, and cooperatively phase the bonding rollers. Such techniques and systems are conventional and well known, and are available from commercial vendors. In desired arrangements, the drive systems can operatively synchronize the rotations of the bonding rollers

The target web and its associated materials are operatively transported or otherwise delivered through the nip region 30 between the cooperating pattern roller 32 and anvil roller 34 to form the desired bonded web. Any transport or delivery system or technique may be employed. Conventional systems and mechanisms, such as roller systems, belts and conveyors, are well known and available from commercial vendors.

The nip region 30 between the bonding rollers can be a variable nip gap distance or a substantially fixed, nip gap distance. Desirably, the method and apparatus can be configured to provide a variable nip gap. The variable nip can self-adjust, depending on the thickness and mechanical properties of the target web 26, the pin pattern parameters, and the total force applied in the nip region.

In a desired aspect, the nip region can be configured to provide a desired, operative nip gap distance 52, and the nip gap distance can be as low as about zero millimeters. In other aspects, the nip gap distance can be up to a maximum of about 5 mm, or more. The nip gap can alternatively be up to about 0.5 mm or about 1 mm, and can optionally be up to about 0.05 mm or about 0.1 mm to provide desired effectiveness.

The pattern roller 32 can be provided with a selected, pattern surface speed, and in a particular aspect, the pattern surface speed can be at least a minimum of about 700 ft/min (about 3.6 m/sec). The pattern surface speed can alternatively be at least about 800 ft/min (about 4.1 m/sec), and can optionally be at least about 900 ft/min (about 4.6 m/sec) to provide desired benefits. In other aspects, the pattern surface speed can be up to a maximum of about 3000 ft/min (about 15.2 m/sec), or more. The pattern surface speed can alternatively be up to about 2000 ft/min (about 10.2 m/sec), and can optionally be up to about 1600 ft/min (about 8.1 m/sec) to provide improved effectiveness.

If the pattern surface speed is outside the desired values, the generated bond strength can be excessively low or exhibit excessive variation. Additionally, excessive breakage of the target web may occur.

In a desired arrangement, the speed of the target web through the nip region 30 can be configured to be substantially equal to the pattern surface speed. Additionally, the anvil roller can be provided with a selected, anvil surface speed, and the pattern surface speed can be configured to be substantially equal to the anvil surface speed. It should be readily appreciated that some differential between the pattern surface speed and the anvil surface speed may occur. In a particular feature, the pattern surface speed may differ from the anvil surface speed by a speed differential that is not more than about 1.5%, as determined with respect to the anvil surface speed. If the surface speed differential is outside the desired values, the bonds may be excessively weak, or the target web may exhibit excessive tearing, breaking or other damage.

A forcing mechanism 54 can be employed to provide a desired bonding pressure value in the nip region 30 between the pattern roller 32 and the anvil roller 34. Any operative forcing mechanism may be employed, and suitable forcing mechanisms are well known in the art and available from commercial vendors. Such forcing mechanisms can, for example, include hydraulic cylinders, pneumatic cylinders, weights, springs and the like, as well as combinations thereof. The forcing mechanism 54 can be configured to provide a variable force or a substantially constant force or pressure value in the nip region 30. Desirably, the method and apparatus can be configured to provide a substantially constant nip force or nip pressure value in the nip region. Suitable forcing mechanisms are conventional and available from commercial vendors.

The bottom roller can be the anvil roller 34, and can be fixed onto a base frame of the method and apparatus, and the top roller can be the pattern roller 32 which is configured to ride on the anvil roller. As representatively shown, the forcing mechanism 54 can include a pair of pneumatic air pressure cylinders which are configured at the ends of the shaft of the pattern roller 32 to symmetrically exert a desired, total force which urges the pattern roller towards the anvil roller. Alternatively, the spatial positions of the pattern roller and anvil roller can be exchanged or otherwise rearranged, and the anvil roller can be fixed to the base and positioned above the pattern roller. Optionally, the pattern roller may be offset along the machine-direction or at any angle with respect to the machine-direction (horizontal-direction) towards either side of the anvil roller. The air pressure cylinders can then be installed to operatively exert a loading force that pushes or otherwise urges the pattern roller against the anvil roller.

In the nip region 30 between the pattern roller 32 and the anvil roller 34, the invention can be configured to provide a distinctive lineal-pressure value, F, which has the units of force per lineal distance, and may also be referred to as the nip force value. The lineal-pressure value can be determined by the formula: F=Q_{T}/L;

where: Q_{T}=the total force which is exerted by the forcing mechanism 54 to urge the pattern roller 32 towards contact with the anvil roller 34;

L=an average length of contact between the peripheral bonding surfaces of the bonding elements and the surface of the anvil roller 34 if the pattern roller contacted the anvil roller, as measured along the axial cross-direction of the anvil roller.

The average length of contact, L, can be determined by the following formula:
L=n*G/S
where: n=the number of pin lines;

G=bonding surface area of an individual bonding element (e.g. bonding surface area of an individual bonding pin);

S=the MD pin spacing distance.

For circular pins; G=(π*d²)÷4. Accordingly, for the circular pins:
L=(n*π*d²)/(4*S)
where: d=the pin diameter (62);
π=3.14.

In particular aspects, the lineal-pressure value can be at least a minimum of about 0.05*10⁶ N/m. The lineal-pressure value can alternatively be at least about 0.5*10⁶ N/m, and can optionally be at least about 1*10⁶ N/m to provide desired benefits. In other aspects, the lineal-pressure value can be up to a maximum of about 10*10⁶ N/m, or more. The lineal-pressure value can alternatively be up to about 6*10⁶ N/m, and can optionally be up to about 4.5*10⁶ N/m to provide desired effectiveness.

If the bonding, lineal-pressure is outside the desired values, the generated bonds may be excessively weak, or the target web may become over-bonded. Undesired holes may be punched through the target web, and excessive material can build up on the bonding pins.

The method and apparatus of the invention can be configured to provide effective bonding strengths even when operated at ambient room temperatures. Typical ambient room temperatures can, for example, be within the range of about 18-32° C. As a result, the invention can operatively provide desired bonding strengths without incorporating or otherwise subjecting the bonding operation to auxiliary heating. It has been found that the technique of the invention can distinctively employ a very rapid, high speed application of the selected bonding nip force (e.g. lineal-pressure value) in a manner that can efficiently and effectively bond webs having similar or dissimilar compositions.

The webs of material selected to form the target web 26 can be configured to have particular melting point values. In a particular aspect, the first web of material 36 has been provided with a first melting point value, and the second web of material 38 has been provided with a second melting point value. The first and second melting point values can be different or substantially the same. In a particular aspect, the first web and the second web can be configured to have first and second melting points which differ by at least about 50° C. or 40° C. The first and second melting point values can alternatively differ by at least about 30° C., and can optionally differ by at least about 10° C. or 20° C. In other arrangements, the difference between first and second melting point values can be as low as about 0° C.

In a further aspect, the material of the first web 36 and the material of the second web 38 can be configured to have first and second melting point values, respectively, wherein either or both of the first and second melting points are not more than a maximum of about 260° C. Either or both of the first and second melting points can alternatively be not more than a maximum of about 225° C., and can optionally be not more than a maximum of about 185° C. to provide desired benefits.

If the melting points are outside the desired values, the target web can be poorly bonded, and excessively high nip forces may be required to adequately deform the target materials. The large nip force can cause excessive wearing of the bonder surfaces, fracture of the pin elements, and excessive instability of the bonding operation.

In the various arrangements of the invention, the web materials can have any operative configuration. For example, at least one of the webs employed to form the target web 26 (e.g. at least one of the first and/or second webs 36, 38) can be a fabric web. In a particular feature, at least one of the selected material webs can be a fabric web having a basis weight which is at least a minimum of about 6 g/m² (about 0.2 osy). The basis weight can alternatively be at least about 10 g/m² (about 0.3 osy), and can optionally be at least about 12 g/m² (about 0.35 osy) to provide desired benefits. In other aspects, the basis weight can be up to a maximum of about 350 g/m² (about 10 osy), or more. The basis weight can alternatively be up to about 200 g/m² (about 5.9 osy), and can optionally be up to about 150 g/m² (about 4.4 osy) to provide desired effectiveness.

In another feature, any or all of the selected material webs (e.g. the first web 36 and/or second web 38) can be a fabric web having a selected density. The fabric web density can be at least a minimum of about 0.04 g/cm³, as determined at a restraining pressure of 1.32 KPa. The density can alternatively be at least about 0.06 g/cm³, and can optionally be at least about 0.07 g/cm³ to provide desired benefits. In other aspects, the density can be up to a maximum of about 0.5 g/cm³, or more. The density can alternatively be up to about 0.3 g/cm³, and can optionally be up to about 0.2 g/cm³ to provide desired effectiveness.

As previously mentioned, at least one of the selected material webs employed to form the target web 26 can include a polymer film. The polymer film can be composed of polyethylene, polypropylene, polyester or the like, as well as combinations thereof. Additionally, the polymer film may be micro-embossed. Desirably, the polymer film can operatively permit a sufficient passage of air and moisture vapor through the thickness dimension of the film while blocking the passage of liquids. An example of a suitable polymer film material can include a breathable, microporous film. In a more particular example, the polymer film material can be a breathable film, which is white in color, dimple embossed, and contains: 47.78% calcium carbonate, 2.22% TiO₂, and 50% polyethylene.

In a particular feature, the employed polymer film web can have a film thickness which is at least a minimum of about 0.008 mm. The film thickness can alternatively be at least about 0.011 mm, and can optionally be at least about 0.013 mm to provide [improved] desired benefits. In other aspects, the film thickness can be up to a maximum of about 0.5 mm, or more. The film thickness can alternatively be up to about 0.3 mm, and can optionally be up to about 0.2 mm to provide desired effectiveness.

The method and apparatus of the invention can provide a desired bonding strength value in the final bonded web 28. In a particular aspect, the composite bonded web 28 can have a composite bonding strength value which is at least a minimum of about 0.38 kg, as determined with respect to a 3-inch wide sample (about 0.5 N/cm). The bonding strength value can alternatively be at least about 0.76 kg (about 1 N/cm), and can optionally be at least about 1 kg (about 1.3 N/cm) to provide desired benefits. In other aspects, the bonding strength value can be up to a maximum of about 8 kg (about 10.5 N/cm), or more. The bonding strength value can alternatively be up to about 6.1 kg (about 8 N/cm), and can optionally be up to about 5 kg (about 6.5 N/cm) to provide desired effectiveness.

The bond strength values can be determined by following the procedures described in the ASTM D 1876-01 “Standard Test Method for Peel Resistance of Adhesives (T-Peel Test)”, with the following modifications. In the test specimens of the bonded webs, the machine-direction of the bond is arranged to extend along the width dimension of the test specimen, and the width dimension of the test specimen is perpendicular to the intended pulling direction of the tensile testing machine. The width of each test specimen measures 76.2 mm (3 inches), instead of 25 mm. A suitable tensile testing system is a MTS ALLIANCE RT/1 machine, which is available from MTS Systems Corporation, a business having offices located in Eden Prairie, Minn., U.S.A. A substantially equivalent tensile tester may alternatively be employed. The gage length (the separation distance between the two grips of the tensile tester) is set to 50±1 mm. The test specimen is gripped such that the manufacturing, machine-direction of the bonded seam region is substantially perpendicular to the pulling direction of the tensile testing machine. The tensile tester applies the testing load at a constant head speed of 508±10 mm/min until the bond (seam) fails or detaches. To determine the bond strength of a particular bonded web, 6 test specimens of the bonded web are prepared and tested to determine the peak force value obtained from each test specimen. The six peak-force values are arithmetically averaged to determine the bond strength of the particular bonded web. The bond strength value and the standard deviation (Stdv) of the corresponding peak-force values are outputted in the units of kilogram (kg), which corresponds to the total force needed to break the 3-inch (76.2 mm) wide bond. It should be noted that for the 3-inch wide specimen, a bonding strength value of 1 kg corresponds to a bonding strength value of 1.31 N/cm.

Additional information and details regarding the peel test procedure are set forth in ASTM D 1876-01 “Standard Test Method for Peel Resistance of Adhesives (T-Peel Test)”. Additional information regarding the MTS tensile tester can be obtained from MTS Systems Corporation, Eden Prairie, Minn., U.S.A.

The method and apparatus of the invention can be configured to provide effective bonding strengths even when operated at ambient room temperatures. Typical ambient room temperatures can, for example, be with the range of about 18-32° C. As a result, the invention can operatively provide desired bonding strengths without incorporating or otherwise subjecting the bonding operation to a separately provided, non-ambient, auxiliary heating. In a particular aspect, the bonding process of the invention can be substantially free of auxiliary heating conducted or applied at an auxiliary-heat temperature that is lower than the melting points of the web materials in the target web, and greater than about 45° C. or about 55° C. The bonding can alternatively be substantially free of auxiliary heating applied at a temperature that is greater than about 65° C. or about 75° C., and can optionally be substantially free of auxiliary heating applied at a temperature that is greater than about 85° C. or about 95° C. It has been found that the technique of the invention can distinctively employ a very rapid, high speed application of the selected bonding nip force (e.g. lineal-pressure value) in a manner that can efficiently and effectively fuse, interlock or otherwise bond webs of materials having similar or dissimilar compositions.

The webs of material selected to form the target web 26 can be configured to have particular melting point values. In a particular aspect, the first web of material 36 has been provided with a first melting point value, and the second web of material 38 has been provided with a second melting point value. The first and second melting point values can be different or substantially the same. In a particular aspect, the first web and the second web can be configured to have first and second melting points which differ by at least about 50° C. The first and second melting point values can alternatively differ by at least about 45° C. or about 40° C., and can optionally differ by at least about 30° C. or about 20° C. In still other arrangements the difference between the first and second melting points can be as low as about zero ° C.

In a further aspect, the material of the first web 36 and the material of the second web 38 can be configured to have first and second melting point values, respectively, wherein at least one of the first and second melting points is not more than a maximum of about 260° C. At least one of the first and second melting points can alternatively be not more than a maximum of about 225° C., and can optionally be not more than a maximum of about 185° C. to provide desired benefits. In other arrangements, a plurality of the web materials in the target web can have the described maximum melting point temperatures.

If the melting points are outside the desired values, the bonding strength may be poor, or the bonding equipment may experience excessive wearing. Additionally, the operation of the bonding equipment may become unstable.

In the various arrangements of the invention, the web materials can have any operative configuration. For example, at least one of the webs employed to form the target web 26 (e.g. at least one of the first and/or second webs 36, 38) can be a fabric web. In a particular feature, at least one or more of the selected material webs can be a fabric web having a basis weight which is at least a minimum of about 0.2 osy (about 6.8 g/m²). The basis weight can alternatively be at least about 8 g/m², and can optionally be at least about 9 g/m² to provide desired benefits. In other aspects, the basis weight can be up to a maximum of about 6 osy (about 204 g/m²), or more. The basis weight can alternatively be up to about 180 g/m², and can optionally be up to about 160 g/m² to provide desired effectiveness.

In another feature, at least one or more of the selected material webs (e.g. the first web 36 and/or second web 38) can be a fabric web having a density which is at least a minimum of about 0.04 g/cm³, as determined at a restraining pressure of 1.32 KPa. The fabric density can alternatively be at least about 0.06 g/cm³, and can optionally be at least about 0.07 g/cm³ to provide desired benefits. In other aspects, the fabric density can be up to a maximum of about 0.5 g/cm³, or more. The fabric density can alternatively be up to about 0.3 g/cm³, and can optionally be up to about 0.2 g/cm³ to provide desired effectiveness.

As previously mentioned, at least one of the selected material webs employed to form the target web 26 can include a polymer film. The polymer film can be composed of polyethylene, polypropylene, polyester or the like, as well as combinations thereof. Additionally, the polymer film may be micro-embossed. Desirably, the polymer film can operatively permit a sufficient passage of air and moisture vapor through the thickness dimension of the film while blocking the passage of liquids. An example of a suitable polymer film material can include a breathable, microporous film. In a more particular example, the polymer film material can be a breathable film, which is white in color, dimple embossed, and contains: 47.78% calcium carbonate, 2.22% TiO₂, and 50% polyethylene.

In a particular feature, the employed polymer film web can have a film thickness which is at least a minimum of about 0.008 mm. The film thickness can alternatively be at least about 0.01 mm, and can optionally be at least about 0.013 mm to provide desired benefits. In other aspects, the film thickness can be up to a maximum of about 0.05 mm, or more. The film thickness can alternatively be up to about 0.03 mm, and can optionally be up to about 0.02 mm to provide desired effectiveness.

A further feature of the bonded web 28 can include a selected, composite basis weight. In a particular aspect, the bonded web can have a composite basis weight which is at least a minimum of about 8 g/m². The composite basis weight can alternatively be at least about 10 g/m², and can optionally be at least about 12 g/m² or about 30 g/m² to provide desired benefits. In other aspects, the composite basis weight can be up to a maximum of about 750 g/m², or more. The composite basis weight can alternatively be up to about 400 g/m² or about 300 g/m², and can optionally be up to about 250 g/m² or about 200 g/m² to provide desired effectiveness.

If the composite basis weight of the bonded web 28 is outside the desired values, the web can exhibit poor bonding. The web may be excessively perforated or may exhibit excessive damage around the perimeters of the bonds.

The following examples describe particular configurations of the invention, and are presented to provide a more detailed understanding of the invention. The examples are not intended to limit the scope of the present invention in any way. From a complete consideration of the entire disclosure, other arrangements within the scope of the claims will be readily apparent to one skilled in the art.

### EXAMPLE-1

In this example, the rotary pressure bonding system employed a FEMACCANICA pressure bonder which was obtained from Fameccanica.Data SpA, a business having offices located in San Giovanni Teatino (Abruzzi), ITALY. The employed web materials included a 0.5 osy (17 g/m²) spunbond-meltblown-spunbond (SMS) laminate, nonwoven fabric composite; a 0.55 osy (18.7 g/m²) spunbond (SB) nonwoven fabric; a 0.00075 inch (0.019 mm) thick printed polyethylene film (PE-p); and a 0.00075 inch (0.019 mm) thick, white (non-printed) polyethylene film (PE-w). Five target web combinations of the web materials were bonded. Bonding speeds varied from 200 feet per minute to 1000 ft/min (fpm) (1.02-5.08 m/sec), and nip forces ranged from 1,800 to 14,500 lb/in (0.32*10⁶-2.6*10⁶ N/m).

As illustrated in FIG. 1, the pressure bonding process and apparatus included a cooperating pair of bonding rollers provided by the representatively shown pattern roller 32 and an anvil roller 34. The anvil roller was substantially fixed on a base, and the pattern roller was configured to ride on the top of the anvil. A forcing mechanism exerted a force which operatively urged the pattern roller towards the anvil roller. For example, the forcing mechanism was located at each end of the axis of the pattern roller and configured to exert a desired force in the direction shown in FIG. 1. The two rollers counter-rotated at surface speeds which were substantially equal to that of the two webs of target material moving forward through the bonder. The two material webs were bonded together when they passed through the nip region of the bonding system.

As configured to produce the bonded webs of the examples, the forcing mechanism included pneumatic cylinders pressurized to the selected pressure values set forth in the present disclosure. Depending upon the employed pattern of bonding elements (e.g. bonding pins) on the pattern roller, the pressurized cylinders would produce a corresponding, lineal bonding pressure or nip force value.

Target webs, which included five combinations of material webs (SMS/PE-p, SB/PE-w, SB/PE-p, SB/SB and SMS/SMS) were bonded, and the resulting bonded webs achieved maximum bond strengths of 1.04, 0.98, 0.94,1.89 and 1.86 kg (1.36, 1.28, 1.23, 2.48 and 2.44 N/cm), respectively. The results show that the method and apparatus of the invention can effectively and efficiently bond both similar and dissimilar combinations of nonwoven fabrics and polymer films at very high speeds to provide high bonding strengths.

The employed web materials were 0.00075 inch (0.019 mm) thick printed polyethylene film (PE-p), and unprinted or white PE films (PE-w), 0.50 osy (17.0 g/m²) SMS and 0.55 osy (18.66 g/m²) SB webs. The basis weights and material strengths of these web materials are summarized in Table 1.

TABLE 1
Properties of the web materials

| Web | Basis weight | Thickness | Strength; cross-direction |
|---|---|---|---|
| material | osy | inch | (CD) Kg |
| PE-w | / | 0.00075 | 2.29 ± 0.30 |
| PE-p | / | 0.00075 | 2.37 ± 0.53 |
| SB | 0.55 | / | 2.51 ± 0.26 |
| SMS | 0.50 | / | 2.44 ± 0.26 |

Note:
1 osy = 33.9 g/m²; 1 inch = 25.4 mm; 1 kg [symbol] 1.31 N/cm.

Using the FAMECCANICA pressure bonder, five combinations of the web materials were bonded. Bonding speeds ranged from 200 to 1000 fpm (1.02-5.08 m/sec), and nip force values ranged from 1800 to 14500 lb/in (0.32*10⁶-2.6*10⁶ N/m). The bonded samples were cut to 3-inch (7.62 cm) long pieces, as measured along the machine-direction of the bonding system, and the bonding strengths of the samples were tested.

The maximum bond strengths achieved for the employed web combinations are listed in Table 2. Also listed in Table 2 are the corresponding machine speed (pattern surface speed) and the nip force value at which the maximum bond strength was achieved. The nip force value was calculated by dividing the total, applied nip force by an effective, average nip-contact length, as measured along the axial direction of the pattern roller. An average, substantially instantaneous nip-contact length can be provided along the radially-outward, peripheral surfaces of the one or more individual bonding elements that are distributed along a line of effective roller contact that extends along the axial length of the employed pattern roller. The line of effective roller contact can be readily observed when the bonding rollers are urged together and the appointed target web is not present in the nip region between the bonding rollers.

TABLE 2
Bond strength achieved by rotary pressure bonding

| Web | Max. bond | Speed | Nip force value |
|---|---|---|---|
| combinations | strength (Kg) | (fpm) | (lb/in) |
| SMS/PE-p | 1.04 | 1,000 | 14,410 |
| SB/PE-w | 0.98 | 1,000 | 10,810 |
| SB/PE-p | 0.94 | 1,000 | 10,810 |
| SMS/SMS | 1.86 | 1,000 | 10,810 |
| SB/SB | 1.89 | 1,000 | 14,410 |

Note the following conversion factors:
1 lb/in [symbol] 179 N/m; 100 fpm [symbol] 0.51 m/sec; 1 kg [symbol] 1.31 N/cm.
Also note that the bond strength (kg) was determined with respect to: specimen width = 3 inches; and number of specimens = 10.

Where the first and second web materials were nonwoven fabrics which were composed of substantially the same materials (e.g. combinations SB/SB and SMS/SMS web materials), the bond strength in the bonded web was up to approximately 80% of the strength of the individual web material.

Where the first and second web materials included combinations of non-compatible web materials (e.g. a combination of PE film bonded to a nonwoven PP web layer), the bond strength can be approximately 50% the strength of the web material that has the relatively lower strength. It is believed that the bond strength may be further improved if the size and pattern of the bonding elements (e.g. bonding pins) were modified.

For the representative web combinations shown in the examples, the bond strengths increased as a function of the bonding speed and nip force value. The bond strength had a high dependence on the bonding speed and nip force value when the bonding speeds and the nip force values were low. When the bonding speeds and nip force values were high, however, the bond strength had a relatively low dependence on the bonding speed and nip force.

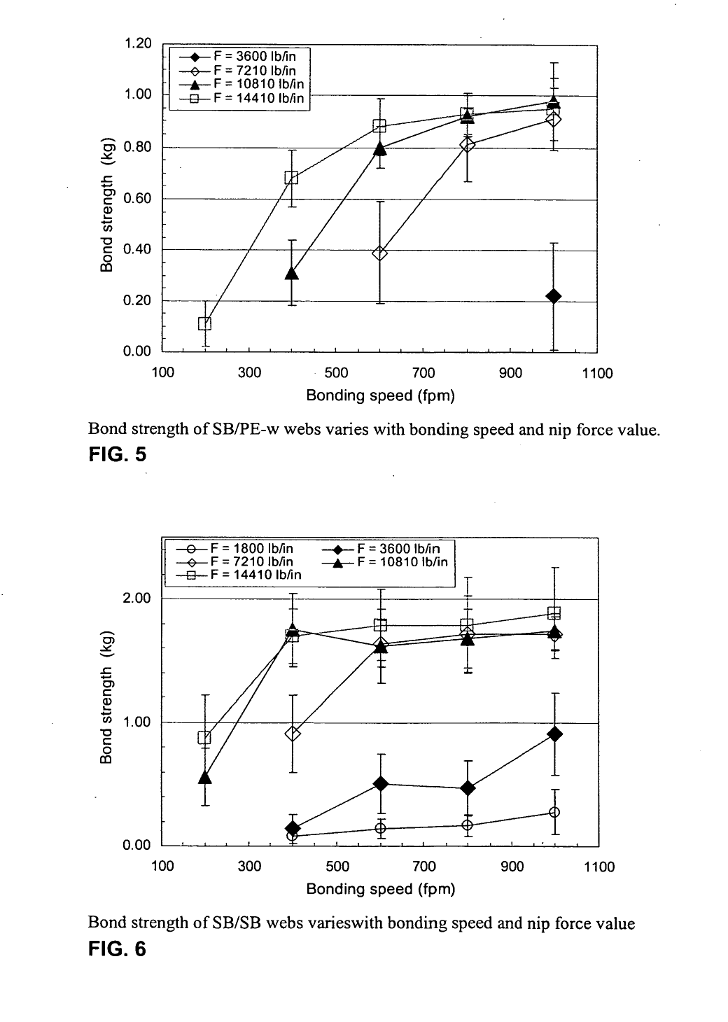

Comparing the results of bonding a SB/PE-w combination with the results of bonding a SB/PE-p combination (e.g. see Table 2, and FIGS. 4 and 5), one can observe that web surface condition had some effect on the bond strength, though the effect can be not as great as the effects produced by the bonding speed and nip force value.

When these results are compared to the results of bonding similar non-compatible webs employing an ultrasonic bonder, it was observed that the process and apparatus of the invention could more strongly bond the thin layers of non-compatible web materials. The different capability of bonding non-compatible webs may be due to a difference in the deformation mechanics of the webs produced by the two kinds of bonding systems. In an ultrasonic bonder, the web materials are typically deformed under a substantially fixed-gap distance condition. In a rotary pressure bonder, however, the web materials are typically deformed under a substantially constant nip force condition.

The test results have shown that the bonding method and apparatus of the invention can effectively bond combinations of two compatible nonwoven fabrics (e.g. SB/SB and SMS/SMS combinations) to bond strength close to 80% of the strength of the employed web material. Additionally, the method and apparatus can effectively bond combinations of two, non-compatible webs (e.g. combinations of PE/SB and PE/SMS web materials) to bond strengths that are approximately 50% of the strength of the PE film. The rotary pressure bonding system of the invention has provided a highly effective, non-adhesive bonding technology for bonding poorly-compatible or non-compatible thin layer materials. The rotary pressure bonding system can be more efficiently and more simply controlled by regulating two, primary process parameters, such as the bonding speed (e.g. pattern surface speed), and the nip force or bonding pressure value.

The structural parameters of the FEMACCANICA pressure bonder, as well as the corresponding pin (bonding element) pattern data are listed in the following Table 3. The pressure bonding tests were conducted at ambient room temperature.

TABLE 3
Parameters of FEMACCANICA pressure bonder and pin pattern.

| Bonder | | | Air cylinder | | | Pin pattern (oval shape pin) | | | | | | | | |
|---|---|---|---|---|---|---|---|---|---|---|---|---|---|---|
| D₁ | D₂ | Heating | D₃ | | | | | D₄ | D₅ | H | S | T | A | |
| mm | mm | units | mm | N_{c} | Nₛ | N_{f} | Nₗ | mm | mm | mm | mm | mm | mm | θ |
| 165 | 176 | NO | 125 | 2 | 1 | 2 | 2 | 2.18 | 1.40 | 0.15 | 3.57 | 1.54 | 1.78 | ±45° |

D₁ - anvil roller diameter;
D₂ - pattern roller diameter;
D₃ - air cylinder diameter;
N_{c} - number of air cylinders installed on the bonder;
Nₛ - number of stages (pistons) of each air cylinder;
N_{f} - number of pin pattern sleeves;
Nₗ - number of pin lines of each pattern sleeve;
D₄ - long axis of ellipse;
D₅ - short axis of ellipse;
H - pin height;
S - pin interval in machine-direction;
T - pin interval in cross-direction;
A - pin offset in machine direction;
θ - slant angle of long axis of ellipse with respect to the machine direction.

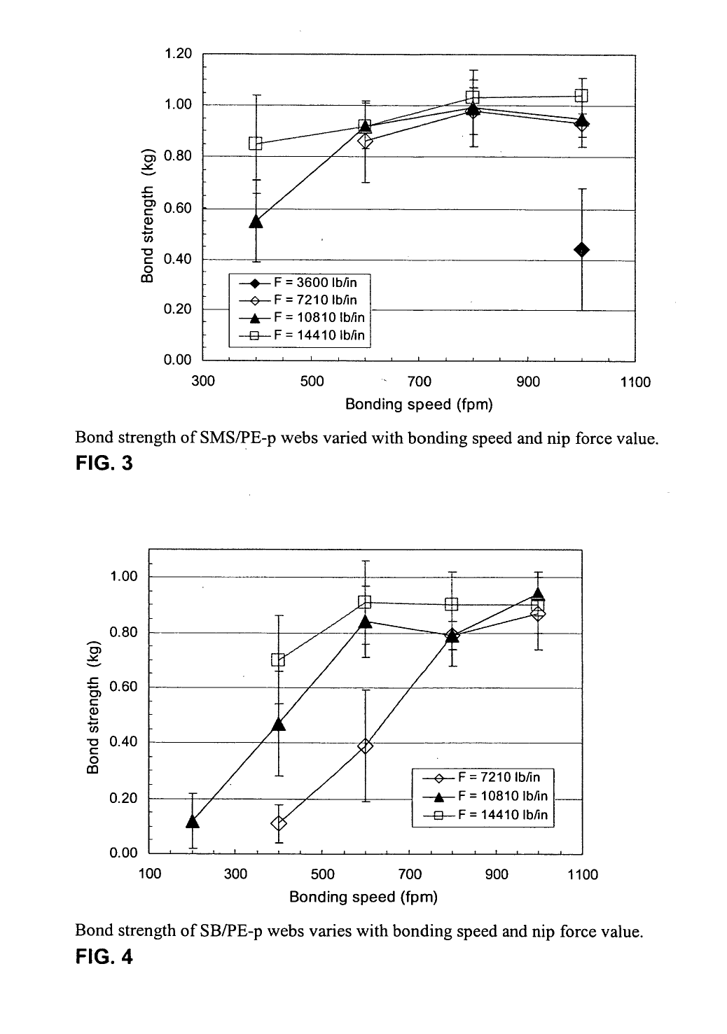

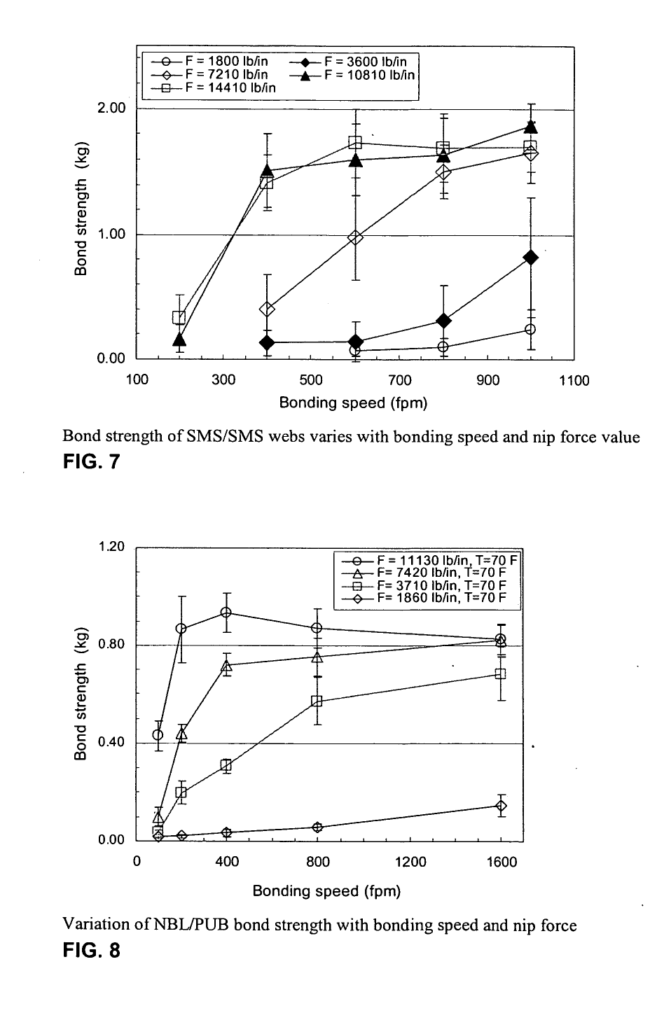

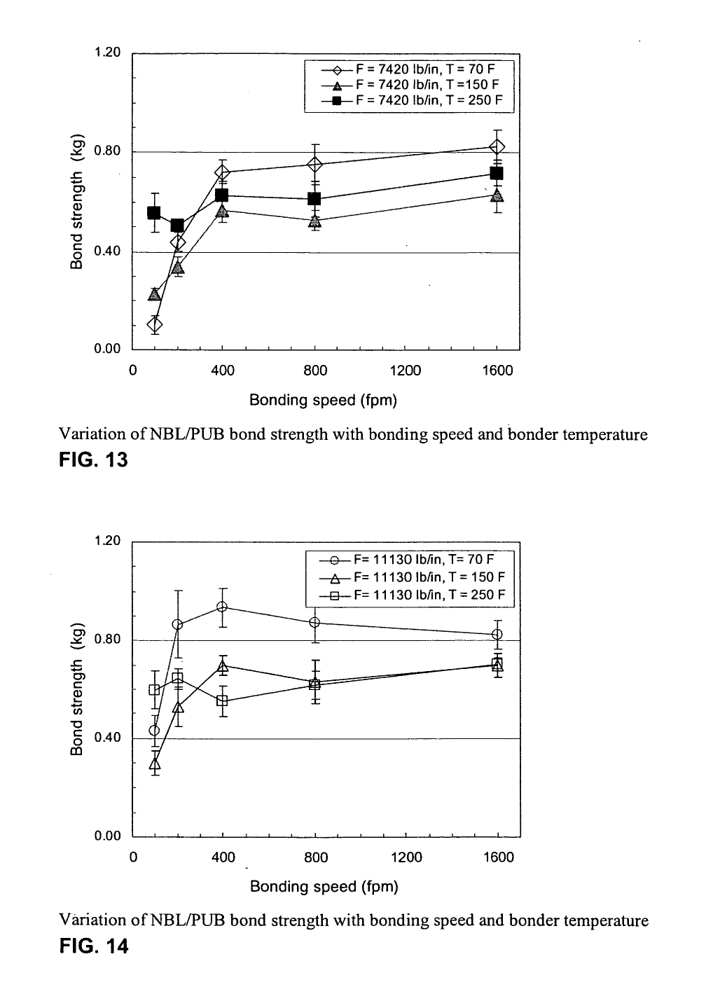

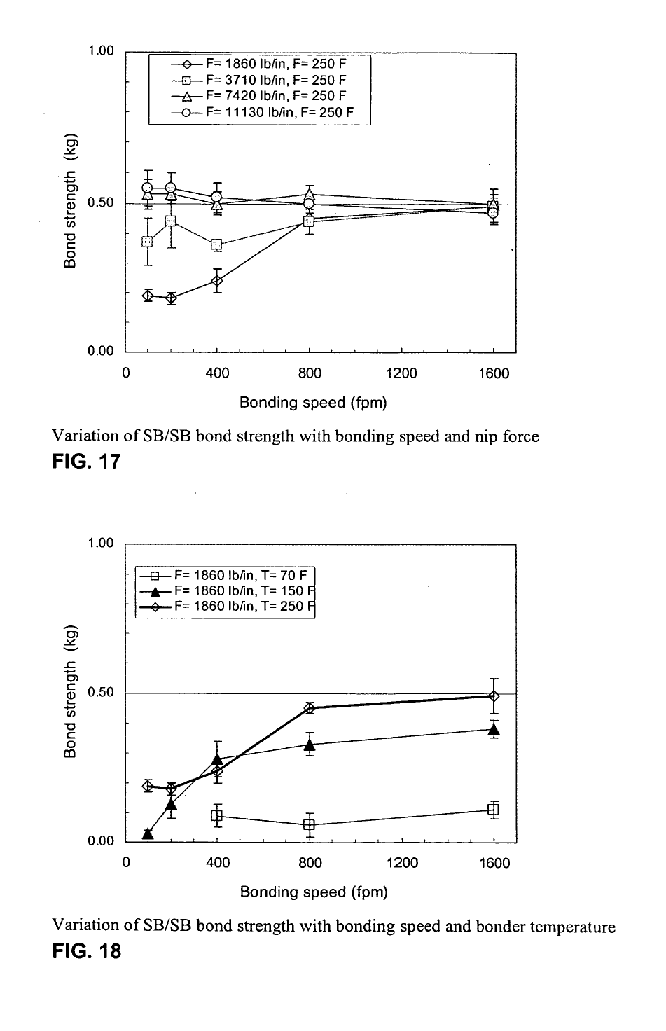

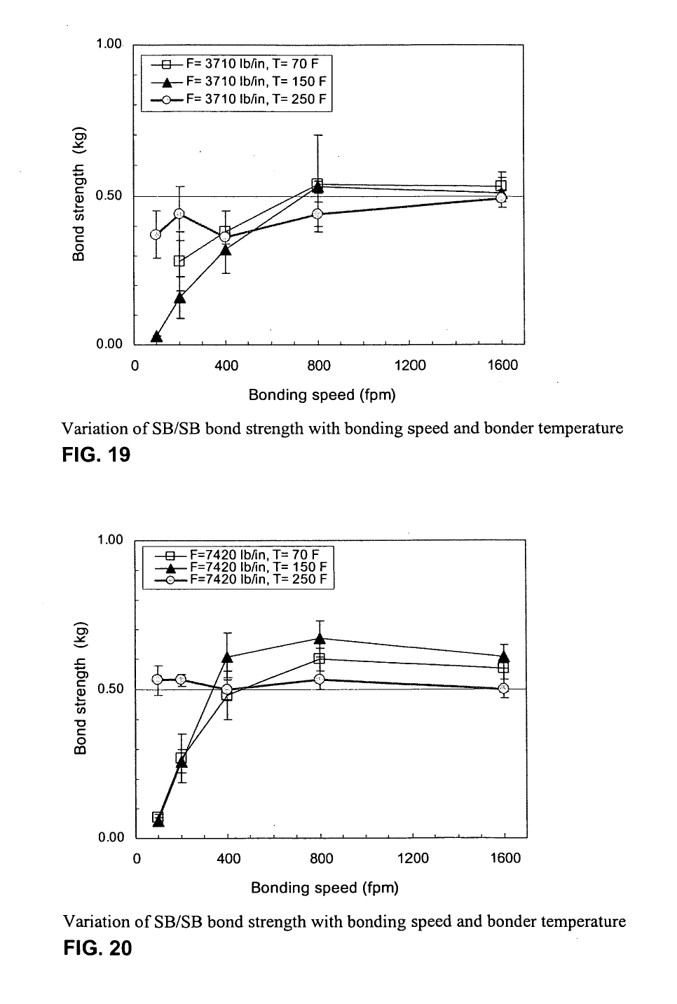

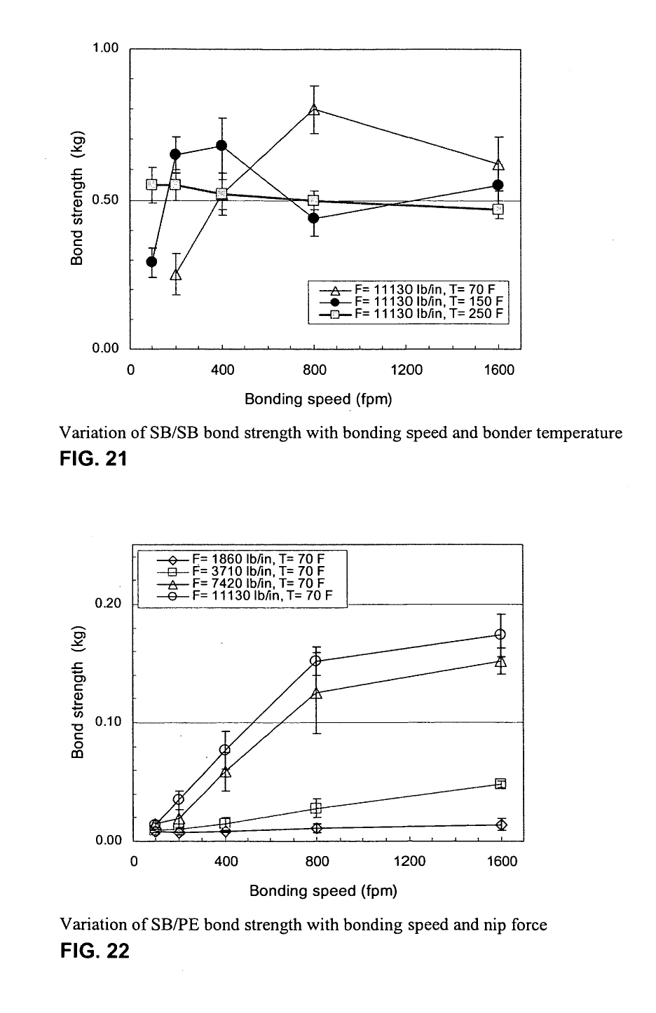

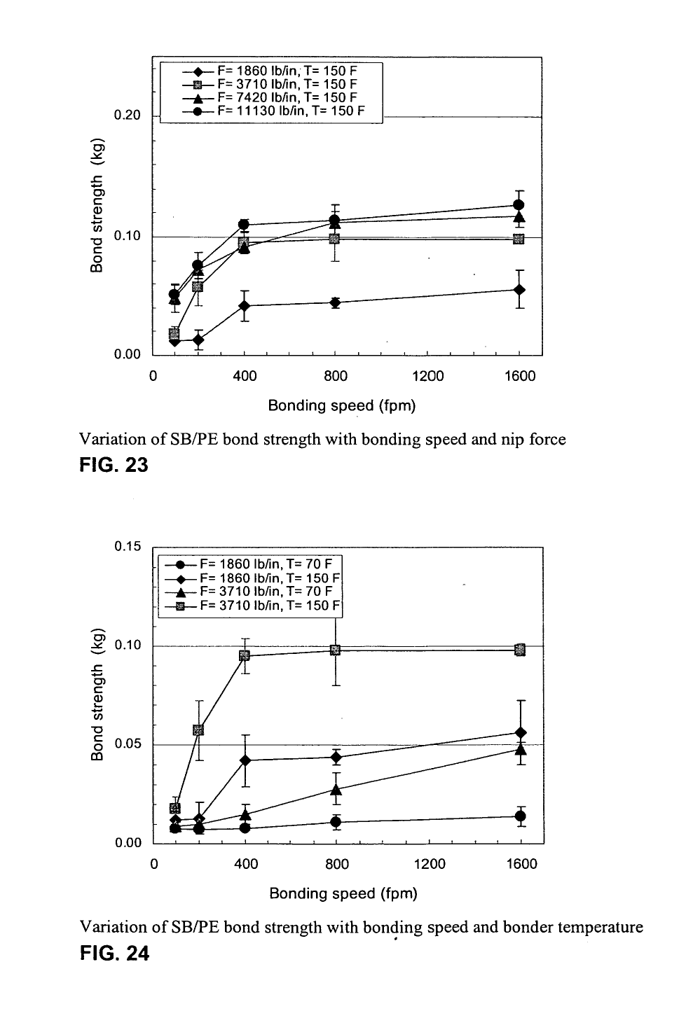

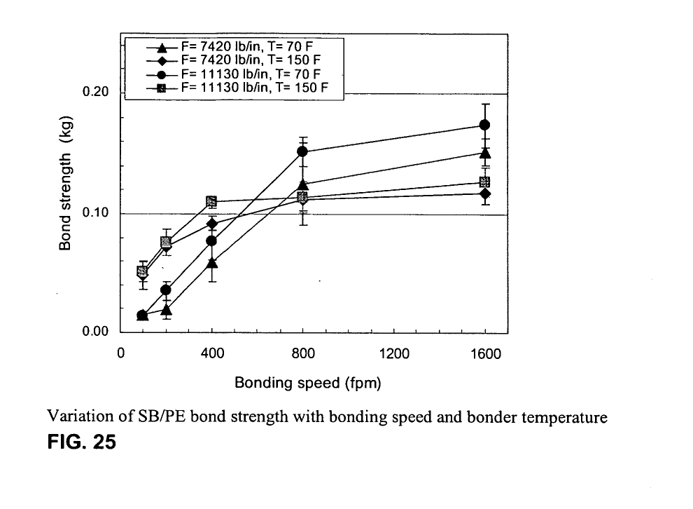

FIGS. 3 through 7 show additional details on how the bond strength of each web combination depended upon the employed pattern surface speeds and the employed nip force values. In FIGS. 3-7 (as well as FIGS. 8-25), the vertical bar associated with an individual data point indicates a range that extends between one standard deviation (1σ) below the corresponding data point, and one standard deviation (1σ) above that data point. It was noted that for all the web material combinations, if a sample bonded web had a bonding strength that was equal or close to the corresponding maximum strength of one of the combined web materials, a web material failure, instead of a bond detachment, was observed during the peel test of the sample of the bonded web. This indicated that the pressure bonding system of the invention could very effectively bond both compatible combinations and non-compatible combinations of web materials. For FIGS. 3-7, note the following conversion factors: 1 lb/in [symbol] 179 N/m; 100 fpm [symbol] 0.51 m/sec; 1 kg [symbol] 1.31 N/cm; where the specimen width=3 inch (7.62 cm) and the number of test specimens=10. Also, note that the bonder temperature T=21° C.

### EXAMPLE-2

Additional examples provided data pertaining to the process variables of bonder temperature, bonding speed and bonding pressure value in the nip region between the bonding rollers. The data also pertain to the influences that these variables can have on the bond strength between different combinations of target web materials.

It has been desirable to eliminate the pre-heating function from the bonding system. Accordingly, the influence of the bonder temperature on the results of the pressure bonding was investigated to more fully understand the fundamental mechanisms of non-adhesive, mechanical bonding. Rotary pressure bonding tests were conducted using a JOA pressure bonder, which was obtained from CURT G. JOA, Inc., a business having offices located in Sheboygan Falls, Wis., U.S.A. The employed pattern roller had the characteristics and parameters set forth in the following Table 4.

TABLE 4
Parameters of JOA pressure bonder and pin pattern.

| Bonder | | | Air cylinder | | | Pin pattern (circular shape pin) | | | | | | |
|---|---|---|---|---|---|---|---|---|---|---|---|---|
| D₁ | D₂ | Heating | D₃ | | | | | D₄ | H | S | T | A |
| mm | mm | units | mm | N_{c} | Nₛ | N_{f} | Nₗ | mm | mm | mm | mm | mm |
| 190.5 | 190.5 | Yes* | 152.4 | 2 | 4 | 1 | 56 | 0.86 | 0.76 | 5.44 | 2.72 | 2.72 |

Note:
The rollers can be heated to a temperature that is about 200° C., or more, above room temperature (about 20° C.).
D₁ - anvil roller diameter;
D₂ - pattern roller diameter;
D₃ - air cylinder diameter;
N_{c} - number of air cylinders installed on the bonder;
Nₛ - number of stages (pistons) of each air cylinder;
N_{f} - number of pin pattern sleeves;
Nₗ - number of pin lines of each pattern sleeve;
D₄ - pin diameter;
H - pin height;
S - pin interval in machine-direction;
T - pin interval in cross-direction;
A - pin offset in machine direction.

Employing the JOA pressure bonder, bonding tests were conducted on the following combinations of target web materials: NBL/PUB; SB/SB; and SB/PE film. The bonder temperature was varied from ambient room temperature to about 250° F. (about 121° C.), the bonding speed was within the range of about 100-1,600 ft/min (about 0.51-8.13 m/sec), and bonder nip force value was in the range of about 1,860-11,130 lb/in (about 0.33*10⁶-1.99*10⁶ N/m).

For pressure bonding at room temperature, the web bond strength increased rapidly with bonding speed and pressure. For pressure bonding at room temperature and low speeds, the web bond was generally weak even at very high bonding pressure values. The bond strength, however, increased dramatically with increased bonder temperature. In other words, a conventional pre-heating of the bonder was necessary to obtain a desired, sufficient bond when the bonding speed was low.

For a given combination of web materials, a pressure-dependent threshold speed was observed. When the bonding speed is lower than this threshold speed, preheating bonder improved the bonding results. When the bonding speed was higher than the threshold speed, however, increasing the bonder temperature would decrease the bond strength. For pressure bonding at room temperature at high speeds, the web bond could be very strong, provided the bonding pressure was high enough, and the bonder system did not need to be pre-heated to get a good bond.

Webs used in the following examples were 0.0005 inch (0.013 mm) thick unprinted polyethylene film (PE); 3.7 osy (125.6 g/m²) NBL; 2.0 osy (67.9 g/m²) PUB; and 0.6 osy (20.4 g/m²) SB webs. The PUB material is described in detail in examples of suitable point-unbonded fabrics in U.S. Pat. No. 5,858,515 entitled PATTERN-UNBONDED NONWOVEN WEB AND PROCESS FOR MAKING THE SAME, by T. J. Stokes et al., which issued Jan. 12, 1999 (attorney docket No. 12,232), the entire disclosure of which is incorporated herein by reference in a manner that is consistent herewith. The basis weights and material strengths of the employed web materials are listed in the following Table 5.

TABLE 5
Properties of webs

| Web | Basis weight | Thickness | Strength (CD) |
|---|---|---|---|
| material | (osy) | (in) | (kg) |
| PE | / | 0.0005 | 0.56 ± 0.01 |
| NBL | 3.7 | / | 5.72 ± 0.26 |
| PUB | 2.0 | / | 8.66 ± 0.37 |
| SB | 0.6 | / | 1.68 ± 0.18 |

Note:
1 osy = 33.9 g/m²; 1 inch = 25.4 mm; 1 kg [symbol] 1.31 N/m.

The various configurations of web materials and the various parameters of the bonding operation are listed in Table 6. Since the polyethylene film used melted at a temperature of about 250° F. (about 121° C.), sample combinations which included the polyethylene film were not tested at 250° F. Where the web configuration included a PUB material, the sample target web was arranged such that the PUB material faced towards the pattern roller. Where the web configuration included a PE film, the target web was arranged such that PE film material faced towards the anvil roller.

TABLE 6

| | | Air | | Bonder |
|---|---|---|---|---|
| Bonded Web | Speeds | Pressure | Nip force | temperature |
| configurations | fpm | psi | lb/in | ° F. |
| NBL/PUB | 100 | 2 | 1860 | 70 (21° C.) |
| SB/SB | 200 | 4 | 3710 | 150 (66° C.) |
| PE/SB | 400 | 8 | 7420 | 250 (121° C.) |
| | 800 | 12 | 11130 | |

Note the following conversion factors:
1 lb/in [symbol] 179 N/m; 100 fpm [symbol] 0.51 m/sec.

Samples of the resulting bonded webs were cut to 3 inch (7.62 cm) long specimens, as measured along the bonding, machine-direction, and the bond strengths of five test specimens were tested on the MTS tensile tester. Pressure bonding tests conducted on a target web composed of NBL/PUB combination of web materials provided the results summarized in FIGS. 8-14.

At a room temperature of 21° C., when the applied bonding pressure was low, such as a nip force value less than 4,000 lb/in (0.71*10⁶ N/m), the bond strength increased as the bonding speed increased (e.g. see FIG. 8). At a high bonding pressure (e.g. bonding pressure greater than 8,000 lb/in (1.43*10⁶ N/m), the bond strength increased dramatically in the low speed range (e.g. bonding speed less than 2.0 m/sec (400 ft/min)). The rate of increase then slowed in the high speed range. For example, see the curves for F=3710 and 7420 lb/in (0.66*10⁶ and 1.33*10⁶ N/m) in FIG. 8. At a very high bonding pressure, when the applied nip force was larger than 11130 lb/in (1.99*10⁶ N/cm), the bond strength initially increased with bonding speed (FIG. 8). The bond strength then decreased gradually when the bonding speed was increased further; a behavior which indicated an over-bonding condition.

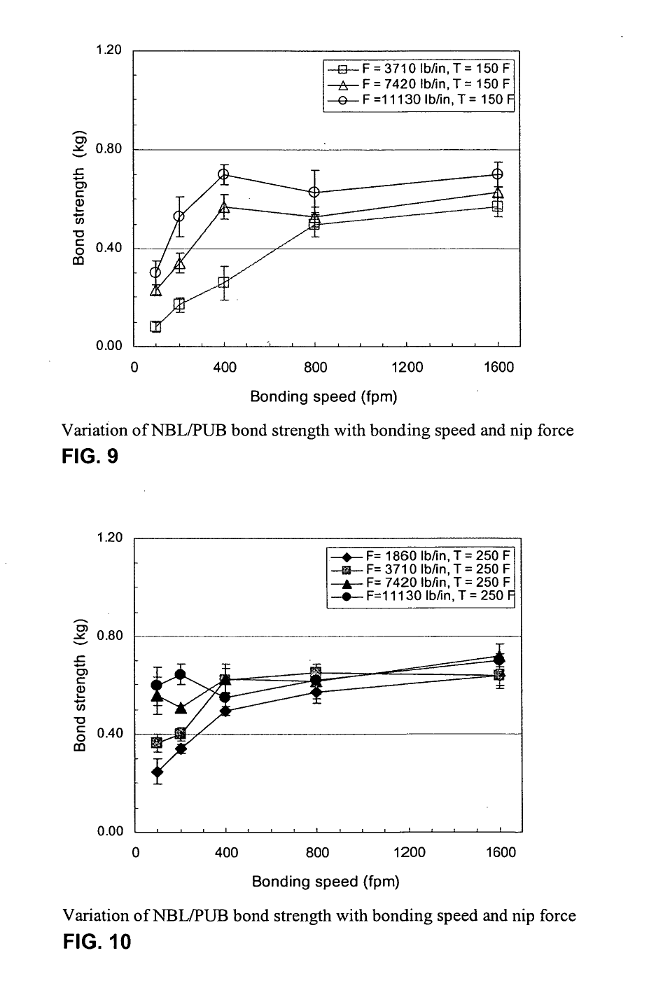

When the bonder temperature was 150° F. (65.5° C.), it can be seen from FIG. 9 that the bond strength, in general, increased as the bonding speed and pressure increased. When bonder temperature was 250° F. (121° C.), it can be seen from FIG. 10 that the pressure effect on the bond strength at low speeds was very different from the pressure effect observed at high speeds. In the low speed range, the bond strength was very sensitive to bonding pressure. In particular, the bond was weak if the bonding pressure was low, and the bond was very strong when bonding pressure was high. In the high speed range, however, the target webs could be bonded very well at very low pressures. For example, see the curve for F=1860 lb/in (0.33*10⁶ N/m) in FIG. 10. Further increasing the bonding pressure, however, resulted in a very small improvement in the bond strength.

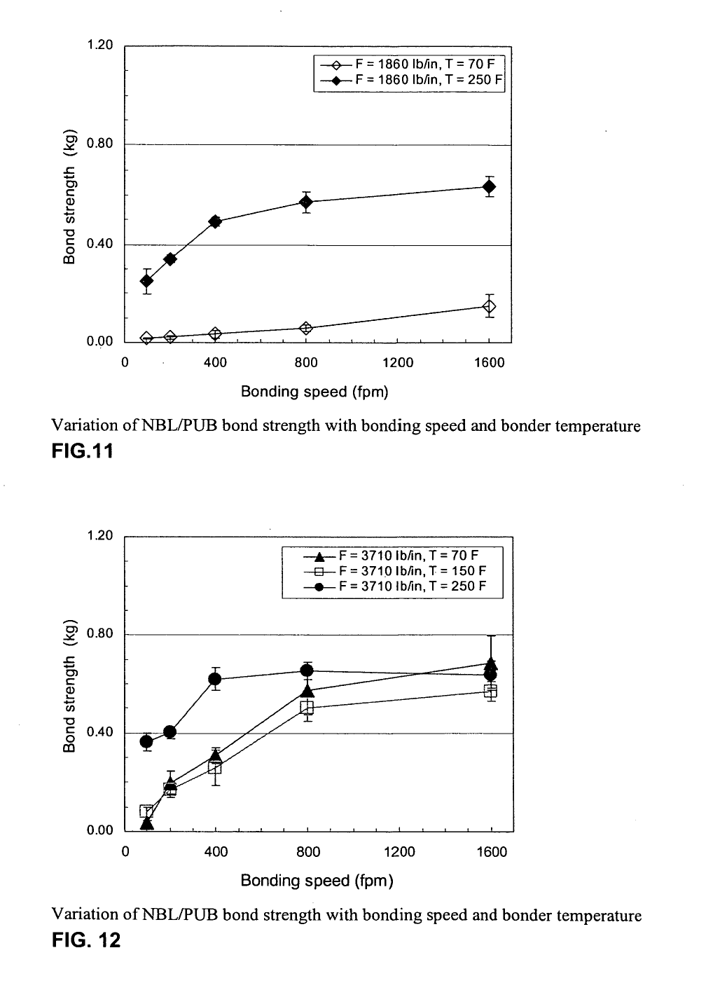

From FIGS. 11-14, it can be seen that there existed a pressure-dependent threshold bonding speed, which divided the bonder temperature effect on the pressure bonding into two ranges. This threshold bonding speed was a reverse function of pressure. When bonding speed was lower than this threshold speed, raising the bonder temperature correspondently increased the web bond strength. However, when the bonding speed was higher than the threshold speed, increasing the bonder temperature decreased the web bond strength. With a low bonding pressure, pre-heating the bonder to 250° F. (121° C.) improved the bonding dramatically within the entire range of bonding speeds. For example, see the curve for F=1860 lb/in (0.33*10⁶ N/m) in FIG. 11. At a high bonding pressure, when bonding speed was lower than 200 fpm (1.01 m/sec), the web bond strength increased with an increased temperature of the pre-heated bonder. For example, see the curve for F=11,130 lb/in (1.99*10⁶ N/m) in FIG. 14. When the bonding speed was higher than 200 fpm (1.01 m/sec), however, the bond strength decreased when the temperature of the pre-heated bonder was increased.

For rotary pressure bonding at room temperature (about 21° C.), when both the bonding pressure and the bonding speed were low, the web bonds were very weak. In the low speed bonding, preheating the bonder dramatically improved the bond strength. Therefore, at low bonding speeds, thermal bonding by preheating the bonder is the best way to obtain a good bonding result.

The bond strength, however, increased dramatically when employing an increased bonding speed and increased bonding pressure. Without intending to be bound by any particular theory, it is believed that in the high speed bonding, the webs were bonded adiabatically during a rapid, mechanical deformation process. Preheating the bonder was not needed to achieve an adequate bond strength, and preheating the bonder decreased the bond strength when the bonding pressure was relatively high.

A pressure-dependent threshold speed was observed for a given combination of web materials. When the bonding speed (e.g. pattern surface speed) was lower than the threshold speed, increasing the bonder temperature increased the bond strength. If the bonding speed was higher than the threshold speed, however, increasing the bonder temperature would decrease the bond strength.

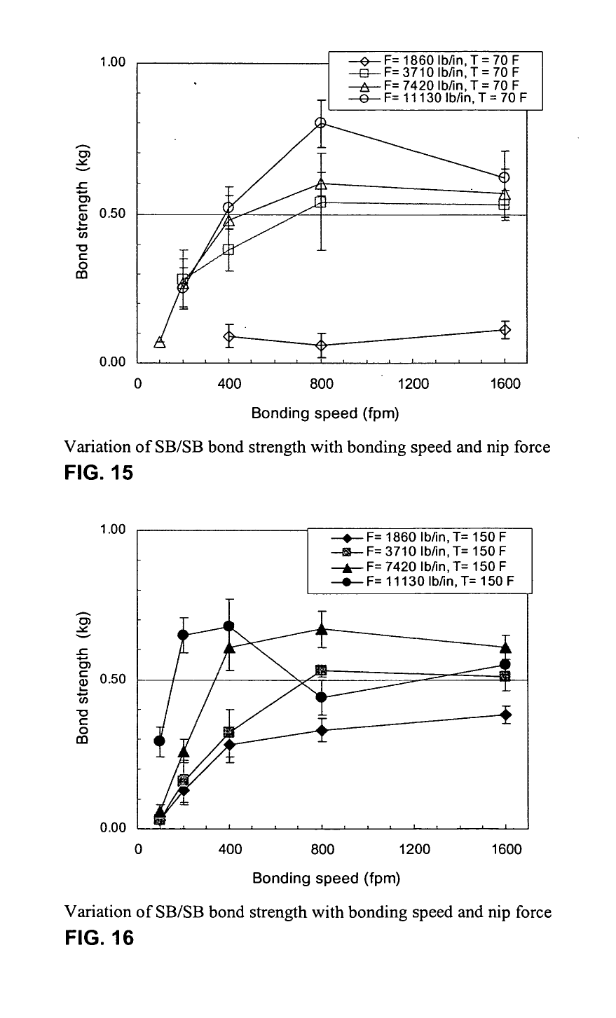

The results of pressure bonding trial for webs having a combination of SB/SB materials are plotted in FIGS. 15 through 21, and the results for webs having the combination of SB/PE film are shown in FIGS. 22 through 25. Comparing the plots for the SB/SB and SB/PE combinations with the corresponding plots for NBL/PUB combination, it was found that the remarks pertaining to the tests for the NBL/PUB combination web in the previous section were also applicable to the results of SB/SB and SB/PE combination webs. For the SB/PE combination web, the bond strength at the 250° F. (121° C.) bonder temperature was not obtained since the PE film would have melted at this temperature.

In FIGS. 8-25 note that for the bonder temperature T: 70° F. (21° C.); 150° F. (66° C.); 250° F. (121° C.). Also note the following conversion factors: 1 lb/in [symbol] 179 N/m; 100 fpm [symbol] 0.51 m/sec; 1 kg [symbol] 1.31 N/cm where specimen width=3 inches (7.62 cm) and number of test specimens=5.

### EXAMPLE-3

Further examples examined the effects of the pattern roller diameter on the rotary pressure bonding (RPB) method and apparatus of the invention. To evaluate the effects of roll diameter on RPB, two trials were carried out: the first trial was using a bonder with a 176 mm diameter pattern roll, Fameccanica pressure bonder (FAME), and a development pressure bonder (DPB) with a 304.47 mm diameter bonder. Neither the FAME nor the DPB employed an auxiliary heating unit. Details of the pressure bonders are set forth in the following Table 7.

TABLE 7
Parameters of pressure bonders and pin patterns

| Bonder | | | Air cylinder | | | Pin pattern (circular shape pin) | | | | | | |
|---|---|---|---|---|---|---|---|---|---|---|---|---|
| | D₁ | D₂ | D₃ | | | | | D₄ | H | S | T | A |
| | mm | mm | mm | N_{c} | Nₛ | N_{f} | Nₗ | mm | mm | mm | mm | mm |
| DPB | 304.47 | 304.47 | 152.4 | 2 | 4 | 2 | 3.5* | 0.91 | 0.79 | 1.59 | 1.33 | 0.45 |
| FAME | 165 | 176 | 125 | 2 | 1 | 2 | 3.5* | 0.91 | 0.79 | 1.59 | 1.33 | 0.45 |

*The number of pins in the fourth line is reduced to the half of the other lines by skipping a pin for every other pin; or in the other words, the pin interval in the fourth line is 2S, i.e., 3.18 mm.
D₁ - anvil roller diameter;
D₂ - pattern roller diameter;
D₃ - air cylinder diameter;
N_{c} - number of air cylinders installed on the bonder;
Nₛ - number of stages (pistons) of each air cylinder;
N_{f} - number of pin pattern sleeves;
Nₗ - number of pin lines of each pattern sleeve;
D₄ - pin diameter;
H - pin height;
S - pin interval in machine-direction;
T - pin interval in cross-direction;
A - pin offset in machine direction.

The bonding speeds employed for the two trials were varied from 100 to 1,200 fpm (0.51 to 6.10 m/sec). The employed bonding nip forces were varied from 3,000 to 25,800 lb/in (0.54*10⁶-4.61*10⁶ N/m) for the 176 mm, FAMECCANICA bonder trial, and were varied from 3,700 to 31,500 lb/in (0.66*10⁶-5.63*10⁶ N/m) for the 304.47 mm bonder trial.

In the bonding tests, 4.3 osy (145.9 g/m²) NBL, 2 osy (67.9 g/m²) PUB, 0.65 osy (22.1 g/m²) SMS, 0.55 osy (18.7 g/m²) SB, and 0.00075 inch (0.019 mm) thick PE film were used to form NBL/PUB, SMS/SMS, SMS/PE and SB/PE web combinations. The properties of the webs are summarized in the following Table 8.

TABLE 8
Properties of webs

| | | | |
|---|---|---|---|
| Web | Basis weight (osy) | CD Strength | Stdv** |
| material | Labeled/Measured | (kg) | (kg) |

| | | | | |
|---|---|---|---|---|
| NBL | 4.30 | 4.45 | 7.70 | 0.19 |
| PUB | 2.00 | 2.09 | 9.17 | 0.59 |
| SMS | 0.65 | 0.64 | 3.01 | 0.27 |
| SB | 0.55 | 0.54 | 2.87 | 0.06 |
| PE* | 0.00075 inch | / | 1.98 | 0.18 |
| VFL | 3.07 | 4.17 | 13.59^{#} | 1.53 |

Note:
*PE films are measured in thickness (inch), instead of basis weight (osy).
^{#}For the VFL, it is MD strength of the VFL since webs are bonded along the CD (cross-direction) of the VFL.
**Stdv = Standard deviation.
1 osy = 33.9 g/m²; 1 inch = 25.4 mm; 1 kg [symbol] 1.31 N/cm.

Samples of the resulting bonded webs were cut to 3 inch (7.62 cm) long specimens, as measured along the bonding, machine-direction, and the bond strengths of five test specimens were tested on the MTS tensile tester.

The testing results showed that the effect of roller diameter can be highly coupled with web material properties and trial conditions. For the combination of VFL bonded to VFL (VFL/VFL), at high-speed bonding, the larger roller diameters can achieve higher bond strengths. At 1200 fpm (6.1 m/sec) speed, for example, at least a 15% increase in bond strength can be observed when the roller diameter is increased from 176 mm to 304 mm. However, at speeds less than 600 fpm (3 m/sec), the smaller diameter bonding rollers can provide better bonding.

For NBL/PUB, in general, the smaller diameter bonding rollers can provide better bonding. At 1200 fpm (6.1 m/sec) speed, for example, a 30% decrease in bond strength was observed when the bonder roll diameter increases from 176 mm to about 304 mm.

For SMS/SMS, the bond strength was less sensitive to the roller diameters of the bonders. For example, the difference between the bond strengths of the webs bonded with 176 mm and 304 mm bonding rollers was several percent in the speed range from 800 to 1200 fpm (4.1 to 6.1 m/sec).

For non-compatible SMS/PE and SB/PE webs, the 304 mm bonder provided better bonding for bonding speeds at or over 1200 fpm (6.1 m/sec). For bonding speeds lower than 800 fpm (4.1 m/sec), however, the 176 mm bonding roller provided better bonds.

The trial conditions and the bonding strengths for a VFL/VFL combination of webs that were bonded together by the method and apparatus of the invention are set forth in the following Table 9.

TABLE 9

| | Pattern roll D2 = 176 mm | | | Pattern roll D2 = 304.47 mm | | |
|---|---|---|---|---|---|---|
| | Anvil roll D1 = 165 mm | | | Anvil roll D1 = 304.47 mm | | |
| V | F | Strength | Stdv | F | Strength | Stdv |
| (m/sec) | (10⁶ N/m) | (kg) | (kg) | (10⁶ N/m) | (kg) | (kg) |
| 0.51 | 0.58 | 0.37 | 0.11 | 0.66 | 0.18 | 0.02 |
| | 1.15 | 1.13 | 0.11 | 1.66 | 0.64 | 0.14 |
| | 1.73 | 1.54 | 0.17 | 2.65 | 1.19 | 0.17 |
| | 2.30 | 1.73 | 0.19 | 3.97 | 1.38 | 0.14 |
| | 3.45 | 2.61 | 0.44 | 5.63 | 1.85 | 0.11 |
| | 4.60 | 3.97 | 0.12 | / | / | / |
| 1.02 | 0.58 | 0.31 | 0.03 | 0.66 | 0.22 | 0.03 |
| | 1.15 | 1.44 | 0.06 | 1.66 | 1.27 | 0.14 |
| | 1.73 | 1.95 | 0.14 | 2.65 | 1.79 | 0.13 |
| | 2.30 | 2.37 | 0.12 | 3.97 | 2.20 | 0.22 |
| | 3.45 | 2.75 | 0.13 | 5.63 | 2.29 | 0.15 |
| | 4.60 | 4.41 | 0.27 | / | / | / |
| 2.03 | 0.58 | 0.40 | 0.09 | 0.66 | 0.30 | 0.07 |
| | 1.15 | 2.16 | 0.21 | 1.66 | 1.76 | 0.21 |
| | 1.73 | 2.51 | 0.20 | 2.65 | 2.43 | 0.34 |
| | 2.30 | 2.95 | 0.15 | 3.97 | 3.32 | 0.20 |
| | 3.45 | 3.48 | 0.24 | 5.63 | 3.59 | 0.39 |
| | 4.60 | 4.07 | 0.20 | / | / | / |
| 4.06 | 0.58 | 0.60 | 0.14 | 0.66 | 0.49 | 0.07 |
| | 1.15 | 1.62 | 0.98 | 1.66 | 2.34 | 0.27 |
| | 1.73 | 2.82 | 0.31 | 2.65 | 3.51 | 0.38 |
| | 2.30 | 2.56 | 0.73 | 3.97 | 3.54 | 0.60 |
| | 3.45 | 3.28 | 0.30 | 5.63 | 3.87 | 0.46 |
| | 4.60 | 3.39 | 0.22 | / | / | / |
| 6.10 | 0.58 | 0.45 | 0.15 | 0.66 | 0.40 | 0.13 |
| | 1.15 | 2.01 | 0.44 | 1.66 | 2.71 | 0.39 |
| | 1.73 | 2.41 | 0.23 | 2.65 | 3.27 | 0.62 |
| | 2.30 | 2.98 | 0.31 | 3.97 | 3.84 | 0.45 |
| | 3.45 | 2.69 | 0.24 | 5.63 | 3.91 | 0.49 |
| | 4.60 | 3.40 | 0.20 | / | / | / |

Note:
Stdv = Standard deviation; for bond strength, 1 kg [symbol] 1.31 N/cm.

The effects of the bonder roll diameter on the pressure bonding of VFL/VFL webs were reviewed. It can be seen that for the VFL/VFL webs, the bonder with smaller diameter bonder rollers can provide better bonding results at low bonding speeds, while at high-speed bonding conditions, the bonder with larger diameter bonder rollers can provide better bonding.

The trial conditions and the bonding strengths of a NBL/PUB combination of webs that were bonded by the method and apparatus of the invention are set forth in the following Table 10.

TABLE 10

| | Pattern roll D2 = 176 mm | | | Pattern roll D2 = 304.47 mm | | |
|---|---|---|---|---|---|---|
| | Anvil roll D1 = 165 mm | | | Anvil roll D1 = 304.47 mm | | |
| V | F | Strength | Stdv | F | Strength | Stdv |
| (m/sec) | (10⁶ N/m) | (kg) | (kg) | (10⁶ N/m) | (kg) | (kg) |
| 0.51 | 0.58 | 0.130 | 0.050 | 1.66 | 0.400 | 0.080 |
| | 1.15 | 1.030 | 0.110 | 2.65 | 0.590 | 0.100 |
| | 1.73 | 0.990 | 0.740 | 3.31 | 0.720 | 0.080 |
| | 2.30 | 1.500 | 0.270 | 3.97 | 0.740 | 0.090 |
| | 2.88 | / | / | 5.63 | 1.090 | 0.170 |
| 1.02 | 0.58 | 0.140 | 0.070 | 1.66 | 0.700 | 0.120 |
| | 1.15 | 1.620 | 0.120 | 2.65 | 1.060 | 0.090 |
| | 1.73 | 1.830 | 0.280 | 3.31 | 1.230 | 0.060 |
| | 2.30 | 2.380 | 0.180 | 3.97 | 1.270 | 0.080 |
| | 2.88 | / | / | 5.63 | 1.600 | 0.12 |
| 2.03 | 0.58 | 0.250 | 0.110 | 1.66 | 1.220 | 0.080 |
| | 1.15 | 2.380 | 0.270 | 2.65 | 1.810 | 0.250 |
| | 1.73 | 2.880 | 0.19 | 3.31 | 1.720 | 0.14 |
| | 2.30 | 3.030 | 0.250 | 3.97 | 1.910 | 0.110 |
| | 2.88 | / | / | 5.63 | 2.110 | 0.26 |
| 4.06 | 0.58 | 1.110 | 0.100 | 1.66 | 1.750 | 0.080 |
| | 1.15 | 2.760 | 0.320 | 2.65 | 2.210 | 0.140 |
| | 1.73 | 2.850 | 0.250 | 3.31 | 2.280 | 0.180 |
| | 2.30 | 3.160 | 0.380 | 3.97 | 2.360 | 0.060 |
| | 2.88 | 3.330 | 0.25 | 5.63 | 2.620 | 0.20 |
| 6.10 | 0.58 | 1.420 | 0.260 | 1.66 | 1.950 | 0.110 |
| | 1.15 | 2.680 | 0.300 | 2.65 | 2.070 | 0.090 |
| | 1.73 | 3.100 | 0.200 | 3.31 | 2.370 | 0.150 |
| | 2.30 | 3.120 | 0.120 | 3.97 | 2.310 | 0.210 |
| | 2.88 | 3.120 | 0.20 | 5.63 | 2.430 | 0.15 |

Note:
Stdv = Standard deviation; for bond strength, 1 kg [symbol] 1.31 N/cm.

The effects of the bonder roll diameter on the pressure bonding of NBL/PUB webs were reviewed. It can be seen that for NBL/PUB webs, the bonder with the smaller diameter bonder rollers can provide better bonding results than the bonder with larger diameter bonding rollers.

The trial conditions and bonding strengths of SMS/SMS webs that were bonded together by the method and apparatus of the invention are set forth in the following Table 11.

TABLE 11

| | Pattern roll D2 = 176 mm | | | Pattern roll D2 = 304.47 mm | | |
|---|---|---|---|---|---|---|
| | Anvil roll D1 = 165 mm | | | Anvil roll D1 = 304.47 mm | | |
| V | F | Strength | Stdv | F | Strength | Stdv |
| (m/sec) | (10⁶ N/m) | (kg) | (kg) | (10⁶ N/m) | (kg) | (kg) |
| 0.51 | 0.58 | 0.070 | 0.000 | 0.66 | No bond | / |
| | 1.15 | 0.070 | 0.010 | 1.66 | No bond | / |
| | 1.73 | 0.120 | 0.070 | 2.65 | No bond | / |
| | 2.30 | 0.150 | 0.080 | 3.31 | No bond | / |
| | 2.88 | / | / | 3.97 | / | / |
| 1.02 | 0.58 | 0.080 | 0.030 | 0.66 | No bond | / |
| | 1.15 | 0.470 | 0.260 | 1.66 | 0.290 | 0.170 |
| | 1.73 | 0.840 | 0.580 | 2.65 | 0.500 | 0.340 |
| | 2.30 | 1.280 | 0.330 | 3.31 | 0.750 | 0.180 |
| | 2.88 | / | / | 3.97 | 0.610 | 0.30 |
| 2.03 | 0.58 | 0.190 | 0.060 | 0.66 | 0.270 | 0.160 |
| | 1.15 | 1.520 | 0.360 | 1.66 | 1.150 | 0.370 |
| | 1.73 | 1.530 | 0.12 | 2.65 | 1.360 | 0.28 |
| | 2.30 | 1.810 | 0.200 | 3.31 | 1.770 | 0.240 |
| | 2.88 | / | / | 3.97 | 1.540 | 0.36 |
| 4.06 | 0.58 | 0.910 | 0.440 | 0.66 | 0.400 | 0.210 |
| | 1.15 | 1.830 | 0.220 | 1.66 | 1.540 | 0.090 |
| | 1.73 | 1.790 | 0.340 | 2.65 | 1.630 | 0.440 |
| | 2.30 | 1.760 | 0.230 | 3.31 | 1.780 | 0.160 |
| | 2.88 | / | / | 3.97 | 1.870 | 0.24 |
| 6.10 | 0.58 | 1.380 | 0.260 | 0.66 | 0.800 | 0.310 |
| | 1.15 | 1.710 | 0.200 | 1.66 | 1.680 | 0.260 |
| | 1.73 | 1.590 | 0.280 | 2.65 | 1.690 | 0.200 |
| | 2.30 | 1.850 | 0.340 | 3.31 | 1.890 | 0.160 |
| | 2.88 | / | / | 3.97 | 1.860 | 0.20 |

Note:
Stdv = Standard deviation; for bond strength, 1 kg [symbol] 1.31 N/cm.

The effects of the bonder roll diameter on the pressure bonding of SMS/SMS webs were reviewed. It can be seen that for SMS/SMS webs the bonder with smaller diameter bonding rollers can provide better bonding results at low bonding speeds, but the bonding results were less affected by bonder roller diameter when the nip force was high.

The trial conditions and bonding strengths of SMS/PE webs bonded by the method and apparatus of the invention are set forth in the following Table 12.

TABLE 12

| | Pattern roll D2 = 176 mm | | | Pattern roll D2 = 304.47 mm | | |
|---|---|---|---|---|---|---|
| | Anvil roll D1 = 165 mm | | | Anvil roll D1 = 304.47 mm | | |
| V | F | Strength | Stdv | F | Strength | Stdv |
| (m/sec) | (10⁶ N/m) | (kg) | (kg) | (10⁶ N/m) | (kg) | (kg) |
| 0.51 | 0.58 | No bond | / | 0.66 | No bond | / |
| | 1.15 | No bond | / | 1.66 | No bond | / |
| | 1.73 | No bond | / | 2.65 | No bond | / |
| | 2.30 | 0.060 | 0.060 | 3.31 | No bond | / |
| | 2.88 | / | / | 3.97 | No bond | / |
| 1.02 | 0.58 | No bond | / | 0.66 | No bond | / |
| | 1.15 | No bond | / | 1.66 | No bond | / |
| | 1.73 | 0.060 | 0.010 | 2.65 | No bond | / |
| | 2.30 | 0.240 | 0.250 | 3.31 | No bond | / |
| | 2.88 | / | / | 3.97 | No bond | / |
| 2.03 | 0.58 | No bond | / | 0.66 | No bond | / |
| | 1.15 | 0.120 | 0.060 | 1.66 | No bond | / |
| | 1.73 | 0.24 | 0.11 | 2.65 | No bond | / |
| | 2.30 | 0.600 | 0.280 | 3.31 | No bond | / |
| | 2.88 | / | / | 3.97 | 0.230 | 0.04 |
| 4.06 | 0.58 | No bond | / | 0.66 | No bond | / |
| | 1.15 | 0.310 | 0.100 | 1.66 | 0.280 | 0.090 |
| | 1.73 | 0.540 | 0.140 | 2.65 | 0.530 | 0.120 |
| | 2.30 | 0.740 | 0.100 | 3.31 | 0.630 | 0.080 |
| | 2.88 | / | / | 3.97 | 0.720 | 0.10 |
| 6.10 | 0.58 | 0.130 | 0.060 | 0.66 | No bond | / |
| | 1.15 | 0.380 | 0.110 | 1.66 | 0.470 | 0.060 |
| | 1.73 | 0.540 | 0.020 | 2.65 | 0.690 | 0.060 |
| | 2.30 | 0.570 | 0.100 | 3.31 | 0.680 | 0.080 |
| | 2.88 | / | / | 3.97 | 0.770 | 0.09 |

Note:
Stdv = Standard deviation; for bond strength, 1 kg [symbol] 1.31 N/cm.

The effect of the bonder roll diameter on the pressure bonding of SMS/PE webs was reviewed. It can be seen that for SMS/PE webs, the bonder with smaller diameter bonding rollers can provide better bonding results at low bonding speeds, while at high bonding speeds the bonding results were less affected by the bonding roller diameters.

The trial conditions and bonding strengths of SB/PE webs bonded by the method and apparatus of the invention are set forth in the following Table 13.

TABLE 13

| | Pattern roll D2 = 176 mm | | | Pattern roll D2 = 304.47 mm | | |
|---|---|---|---|---|---|---|
| | Anvil roll D1 = 165 mm | | | Anvil roll D1 = 304.47 mm | | |
| V | F | Strength | Stdv | F | Strength | Stdv |
| (m/sec) | (10⁶ N/m) | (kg) | (kg) | (10⁶ N/m) | (kg) | (kg) |
| 0.51 | 0.58 | No bond | / | 0.66 | No bond | / |
| | 1.15 | No bond | / | 1.66 | No bond | / |
| | 1.73 | No bond | / | 2.65 | No bond | / |
| | 2.30 | 0.030 | 0.010 | 3.31 | No bond | / |
| | 2.88 | 0.100 | 0.06 | 3.97 | No bond | / |
| 1.02 | 0.58 | No bond | / | 0.66 | No bond | / |
| | 1.15 | 0.020 | 0.000 | 1.66 | No bond | / |
| | 1.73 | 0.030 | 0.020 | 2.65 | No bond | / |
| | 2.30 | 0.100 | 0.040 | 3.31 | 0.080 | 0.020 |
| | 2.88 | 0.210 | 0.05 | 3.97 | No bond | / |
| 2.03 | 0.58 | 0.040 | 0.020 | 0.66 | No bond | / |
| | 1.15 | 0.140 | 0.070 | 1.66 | No bond | / |
| | 1.73 | 0.250 | 0.07 | 2.65 | No bond | / |
| | 2.30 | 0.450 | 0.170 | 3.31 | No bond | / |
| | 2.88 | 0.540 | 0.14 | 3.97 | 0.100 | 0.04 |
| 4.06 | 0.58 | 0.070 | 0.030 | 0.66 | No bond | / |
| | 1.15 | 0.390 | 0.140 | 1.66 | 0.100 | 0.040 |
| | 1.73 | 0.720 | 0.110 | 2.65 | 0.310 | 0.150 |
| | 2.30 | 0.830 | 0.060 | 3.31 | 0.410 | 0.120 |
| | 2.88 | 0.810 | 0.09 | 3.97 | 0.570 | 0.08 |
| 6.10 | 0.58 | 0.300 | 0.050 | 0.66 | No bond | / |
| | 1.15 | 0.520 | 0.120 | 1.66 | 0.290 | 0.080 |
| | 1.73 | 0.620 | 0.140 | 2.65 | 0.600 | 0.130 |
| | 2.30 | 0.710 | 0.060 | 3.31 | 0.750 | 0.080 |
| | 2.88 | 0.810 | 0.08 | 3.97 | 0.840 | 0.06 |

Note:
Stdv = Standard deviation; for bond strength, 1 kg [symbol] 1.31 N/cm.

The effects of the bonder roll diameter on the pressure bonding of SB/PE webs were reviewed. It can be seen that, in general, for SB/PE webs, the bonder with smaller diameter bonding rollers provided better bonding in the bonding speed range of this study.

Those skilled in the art will recognize that the present invention is capable of many modifications and variations without departing from the scope thereof. Accordingly, the detailed description and examples set forth above are meant to be illustrative only and are not intended to limit, in any manner, the scope of the invention as set forth in the appended claims.

1. A bonding method, comprising delivering a target web having selected bonding materials through a nip region between a pattern roller and an anvil roller to form a bonded web; wherein
the bonding materials have included a first web of a selected material and at least a second web of a selected material.
the pattern roller has been provided with a pattern surface speed;
the anvil roller has been provided with an anvil surface speed, with the anvil surface speed substantially equal to the pattern surface speed; and
the pattern surface speed has been at least a minimum of about 3.6 m/sec.

2. A bonding method as recited in claim 1, wherein the pair of bonding rollers have been configured to provide a bonding, lineal-pressure value which is at least about 0.05*10⁶ N/m.

3. A bonding method as recited in claim 1, wherein the pair of bonding rollers have been configured to provide a bonding, lineal-pressure value which is at least about 0.5*10⁶ N/m.

4. A bonding method as recited in claim 1, wherein the pair of bonding rollers have been configured to provide a bonding, lineal-pressure value which is not more than a maximum of about 10*10⁶ N/m.

5. A bonding method as recited in claim 1, wherein the pattern roller has been provided with a pattern surface speed; the anvil roller has been provided with an anvil surface speed; the anvil surface speed has been substantially equal to the pattern surface speed; and the pattern surface speed has been at least about 4.1 m/sec.

6. A bonding method as recited in claim 1, wherein the pattern roller has been provided with a pattern surface speed; the anvil roller has been provided with an anvil surface speed that is substantially equal to the pattern surface speed; and the pattern surface speed has been at least about 4.6 m/sec.

7. A bonding method as recited in claim 1, wherein the pattern roller has been provided with a pattern surface speed; the anvil roller has been provided with an anvil surface speed; the anvil surface speed has been substantially equal to the pattern surface speed; and the pattern surface speed has been provided up to about 15.2 m/sec.

8. A bonding method as recited in claim 1, wherein the pattern surface speed has differed from the anvil surface speed by a speed differential that is not more than about 1.5%, as determined with respect to the anvil surface speed.

9. A bonding method as recited in claim 1, wherein the pair of bonding rollers has included at least one pattern roller having an array of bonding elements distributed on an outer surface of the pattern roller.

10. A bonding method as recited in claim 1, wherein the pattern roller has been provided with a pattern-roll diameter which is not more than a maximum of about 610 mm.

11. A bonding method as recited in claim 1, wherein the pattern roller has been provided with a pattern-roll diameter which is at least about 76 mm.

12. A bonding method as recited in claim 1, wherein the first web of material has been provided with a first melting point; the second web of material has been provided with a second melting point; and at least one of the first and second webs has been a fabric web.

13. A bonding method as recited in claim 1, wherein the first web of material has been configured with a first melting point value; the second web of material has been configured with a second melting point value; at least one of the first and second melting point values is not more than a maximum of about 260° C.

14. A bonding method as recited in claim 1, wherein the material of the first web has been configured to have a first melting point value; the material of the second web has been configured to have a second melting point value; the first and second melting points differ by at least about 30° C.

15. A bonding method as recited in claim 1, wherein at least one of the first and second webs has been a fabric web with a basis weight which is at least about 6 g/m².

16. A bonding method as recited in claim 1, wherein the bonded web has a bonding strength value which is at least a minimum of about 0.5 N/cm.

17. A bonding method as recited in claim 1, wherein the bonded web has a bonding strength value which is at least about 1 N/cm.

18. A bonding method as recited in claim 1, wherein the method is substantially free of auxiliary heating applied at an auxiliary-heat temperature that is lower than the melting points of the web materials in the target web, and greater than about 45° C.

19. A bonding method as recited in claim 1, wherein the method is substantially free of auxiliary heating applied at an auxiliary-heat temperature that is lower than the melting points of the web materials in the target web, and greater than about 55° C.

20. A bonding method as recited in claim 1, wherein the bonded web has a composite basis weight which is at least a minimum of about 8 g/m².
